(19) United States
(12) Patent Application Publication
(10) Pub. No.: US 2020/0387921 A1
(43) Pub. Date: Dec. 10, 2020

(54) METHOD AND APPARATUS FOR ISSUING/PRESENTING A COUPON BASED ON AN INTERFNET PLATFORM

(71) Applicant: KOUBEI (SHANGHAI) INFORMATION TECHNOLOGY CO., LTD., Shanghai (CN)

(72) Inventors: Jingjing SHEN, Shanghai (CN); Bei LIU, Shanghai (CN)

(21) Appl. No.: 16/767,574

(22) PCT Filed: Nov. 14, 2018
(86) PCT No.: PCT/CN2018/115341

§ 371 Date: May 27, 2020

(30) Foreign Application Priority Data
Nov. 27, 2017 (CN) 201711206762.7

(51) Int. Cl. G06Q 30/02

(52) U.S. Cl. CPC G06Q 30/0222; G06Q 30/0239

(57) ABSTRACT

A method and an apparatus for presenting and issuing a coupon based on an internet platform. The presenting method includes: presenting a prompt information on issuing a coupon package, where the coupon package contains two or more sub-coupons; receiving a confirmation-collecting operation corresponding to the coupon package; sending a coupon-package issuing request for the coupon package based on the confirmation-collecting operation; and upon receiving a confirmation information on the coupon-package issuing request, displaying issue information on the coupon package; the sub-coupons contained in the coupon package is listed in the issue information on the coupon package.

### CROSS-REFERENCE OF RELATED APPLICATIONS

This application is a national phase of International Application No. PCT/CN2018/115341 entitled “METHOD AND APPARATUS FOR ISSUING/PRESENTING COUPON BASED ON INTERNET PLATFORM” and filed Nov. 14, 2018, which is incorporated herein by reference in its entirety. The international application claims priority to Chinese patent application No. 201711206762.7 entitled “METHOD AND APPARATUS FOR ISSUING/PRESENTING COUPON BASED ON INTERNET PLATFORM” and filed on Nov. 27, 2017, the disclosure of which is incorporated herein by reference in its entirety.

### TECHNICAL FIELD

The present application relates to the field of application services on e-commerce service platforms, in particular, to a method and an apparatus for presenting a coupon based on an internet platform, and a method and an apparatus for issuing a coupon based on the internet platform.

### BACKGROUND

Issuing coupons is a kind of marketing strategy of e-commerce service platforms, and the contents delivered by the coupons can be set by merchants based on their own requirements.

At present, a method for issuing a coupon is shown in FIG. 1. FIG. 1 illustrates the method for issuing a coupon in the related art, that is: a coupon being displayed on a service platform and being obtained via user's clicking; or a coupon prompt message being displayed on the service platform, a coupon list, which contains information of coupons of a plurality of merchants, being displayed on the platform via a user's clicking action, and a plurality of coupons being collected after the user clicks each merchant's coupon.

The above method for collecting a coupon in the related art has the following drawbacks:

a. The user has to click repeatedly to collect the coupons, which is cumbersome to operate, with low collecting efficiency and poor experience.

b. The promotion efficiency of the merchants is reduced.

How to provide a method for issuing a coupon to overcome the above problems in the related art has become one of the technical problems for those skilled in the art to solve.

### SUMMARY

The present application provides a method and an apparatus for presenting a coupon based on an internet platform, to solve the problem of low marketing strategy efficiency caused by the cumbersome coupon collecting operation in the related art.

The present application provides a method for presenting a coupon based on an internet platform, including:

presenting prompt information on issuing a coupon package, where the coupon package contains two or more sub-coupons;

receiving a confirmation-collecting operation corresponding to the coupon package;

sending a coupon-package issuing request for the coupon package based on the confirmation-collecting operation; and

upon receiving confirmation information on the coupon-package issuing request, displaying issue information on the coupon package; where the sub-coupons contained in the coupon package are listed in the issue information on the coupon package.

In some embodiments, before the step of presenting a prompt information on issuing a coupon package, the method includes:

creating the coupon package containing the two or more sub-coupons.

In some embodiments, creating the coupon package containing the two or more sub-coupons includes:

constructing a coupon issuing activity content of the coupon package, where the coupon issuing activity content includes a coupon-package issuing condition;

selecting sub-coupon issuing activity contents of the sub-coupons corresponding to the coupon issuing activity content, and sub-coupon templates respectively corresponding to the sub-coupon issuing activity contents, where the sub-coupon template defines a coupon type, a coupon amount, a coupon usage restriction and/or a coupon usage instruction of the sub-coupon; and

establishing an association relationship between the sub-coupon issuing activity contents and the coupon issuing activity content, or establishing an association relationship between the coupon issuing activity content and the sub-coupon templates.

In some embodiments, establishing an association relationship between the sub-coupon issuing activity contents and the coupon issuing activity content specifically is:

associating each of the sub-coupon issuing activity contents with the coupon issuing activity content; or

associating the sub-coupon issuing activity contents with one another, and then associating at least one of the sub-coupon issuing activity contents with the coupon issuing activity content; and

establishing an association relationship between the coupon issuing activity content and the sub-coupon templates specifically is:

associating each of the sub-coupon templates with the coupon issuing activity content; or

associating the sub-coupon templates with one another, and then associating at least one of the sub-coupon templates with the coupon issuing activity content.

In some embodiments, creating the coupon package containing the two and more sub-coupons includes:

establishing a coupon issuing activity content of the coupon package and two or more sub-coupon templates, where the coupon issuing activity content includes a coupon-package issuing condition;

generating sub-coupon issuing activity contents matching the coupon issuing activity content based on the coupon issuing activity content, where the sub-coupon issuing activity contents respectively correspond to the sub-coupon templates; and

storing an association relationship between the sub-coupon issuing activity contents and the coupon issuing activity content, or establishing an association between the coupon issuing activity content and the sub-coupon templates.

In some embodiments, before presenting prompt information on issuing a coupon package, the method includes:

determining whether the coupon-package issuing condition of the created coupon package containing the two or more sub-coupons is satisfied, and if a result of the determination is yes, turning to the step of presenting prompt information on issuing a coupon package.

In some embodiments, the coupon-package issuing condition is a time range for issuing, a quantity range for issuing, an issuing type and/or a quantity range for holding.

In some embodiments, displaying issue information on the coupon package includes:

providing an operation prompt for sharing the coupon package in displaying the issue information on the coupon package.

In some embodiments, displaying issue information on the coupon package includes:

providing a storage operation prompt in displaying the issue information on the coupon package, where the storage operation prompt contains a storage location available for storing the coupon package.

In some embodiments, displaying issue information on the coupon package includes:

presenting a viewing operation prompt for viewing the storage location of the coupon package in displaying the issue information on the coupon package.

In some embodiments, displaying issue information on the coupon package includes:

sorting the sub-coupons based on historical consumption records or historical browsing records of a receiver of the coupon package.

In some embodiments, displaying issue information on the coupon package includes:

providing a usage operation prompt for using the coupon package in displaying the issue information on the coupon package, and/or, providing a secondary usage operation prompt for each of the sub-coupons in displaying the issue information on the coupon package.

In some embodiments, providing a usage operation prompt for using the coupon package includes:

upon triggering the usage operation prompt, displaying a selection operation prompt for each of the sub-coupons.

In some embodiments, displaying issue information on the coupon package includes:

providing a usage operation prompt for each of the sub-coupons in displaying the issue information on the coupon package.

In some embodiments, displaying issue information on the coupon package includes:

providing a reminder operation prompt for each of the sub-coupons in displaying the issue information of the coupon package.

In some embodiments, providing a reminder operation prompt for each of the sub-coupons in displaying the information on the coupon package includes:

based on current location information of a user, searching for location information of a merchant which is associated with the sub-coupon presented in the coupon package and matches the current location information, and displaying a usage reminder for the sub-coupon; or

based on a usage time range of the sub-coupon, setting a usage reminder for the sub-coupon presented in the coupon package within the usage time range.

The present application also provides an apparatus for presenting a coupon based on an internet platform, including:

a presenting unit configured to present prompt information on issuing a coupon package, where the coupon package contains two or more sub-coupons;

a collecting-operation receiving unit configured to receive a confirmation-collecting operation corresponding to the coupon package;

an issuing-request sending unit configured to send a coupon-package issuing request for the coupon package based on the confirmation-collecting operation; and

a displaying unit configured to, upon receiving confirmation information on the coupon-package issuing request, display issue information on the coupon package; where the sub-coupons contained in the coupon package are listed in the issue information on the coupon package.

In some embodiments, the apparatus for presenting a coupon based on the internet platform includes:

a creating unit configured to create the coupon package containing the two or more sub-coupons.

In some embodiments, the creating unit includes:

a constructing unit configured to construct a coupon issuing activity content of the coupon package, where the coupon issuing activity content includes a coupon-package issuing condition of the coupon package;

a selecting unit configured to select sub-coupon issuing activity contents of the sub-coupons corresponding to the coupon issuing activity content, and select sub-coupon templates respectively corresponding to the sub-coupon issuing activity contents, where the sub-coupon template defines a coupon type, a coupon amount, a coupon usage restriction and/or a coupon usage instruction of the sub-coupon; and

an establishing unit configured to establish an association relationship between the sub-coupon issuing activity contents and the coupon issuing activity content, or establish an association relationship between the coupon issuing activity content and the sub-coupon templates.

In some embodiments, the creating unit includes:

an establishing unit configured to establish a coupon issuing activity content of the coupon package and a plurality of sub-coupon templates;

a generating unit configured to generate sub-coupon issuing activity contents matching the coupon issuing activity content based on the coupon issuing activity content, where the sub-coupon issuing activity contents respectively correspond to the sub-coupon templates; and

a storage unit configured to store an association relationship between the sub-coupon issuing activity contents and the coupon issuing activity content, or establish an association between the coupon issuing activity content and the sub-coupon templates.

In some embodiments, the apparatus for presenting a coupon based on the internet platform includes:

an issuing-condition determining unit configured to determine whether the coupon-package issuing condition of the created coupon package containing the two or more sub-coupons is satisfied, and if a result of the determination is yes, enable the presenting unit.

The present application provides a method for issuing a coupon based on an internet platform, including:

receiving a coupon-package issuing request for a coupon package; and

parsing the coupon package, to obtain each of sub-coupons contained in the coupon package;

for each of the obtained sub-coupons, sending a sub-coupon issuing request for issuing the sub-coupon to a coupon issuing party;

determining whether a confirmation information on the sub-coupon issuing request corresponding to each of the sub-coupons is received; and if a result of the determination is yes, performing the next step; and

generating a confirmation information on the coupon-package issuing request and sending to a party sending the coupon-package issuing request.

In some embodiments, before the step of receiving a coupon-package issuing request, the method includes:

creating the coupon package containing two or more sub-coupons.

In some embodiments, creating the coupon package containing two or more sub-coupons includes:

constructing a coupon issuing activity content of the coupon package, where the coupon issuing activity content includes a coupon-package issuing condition of the coupon package;

selecting sub-coupon issuing activity contents of the sub-coupons corresponding to the coupon issuing activity content, and sub-coupon templates respectively corresponding to the sub-coupon issuing activity contents, where the sub-coupon template defines a coupon type, a coupon amount, a coupon usage restriction and/or a coupon usage instruction of the sub-coupon; and

establishing an association relationship between the sub-coupon issuing activity contents and the coupon issuing activity content, or establishing an association relationship between the coupon issuing activity content and the sub-coupon templates.

In some embodiments, establishing an association relationship between the sub-coupon issuing activity contents and the coupon issuing activity content specifically is:

associating each of the sub-coupon issuing activity contents with the coupon issuing activity content; or

associating the sub-coupon issuing activity contents with one another, and then associating at least one of the sub-coupon issuing activity contents with the coupon issuing activity content; and

establishing an association relationship between the coupon issuing activity content and the sub-coupon templates specifically is:

associating each of the sub-coupon templates with the coupon issuing activity content; or

associating the sub-coupon templates with one another, and then associating at least one of the sub-coupon templates with the coupon issuing activity content.

In some embodiments, creating the coupon package containing two or more sub-coupons includes:

establishing a coupon issuing activity content of the coupon package and two or more sub-coupon templates, where the coupon issuing activity content includes a coupon-package issuing condition of the coupon package, and the sub-coupon template defining a coupon type, a coupon amount, a coupon usage restriction and/or a coupon usage instruction of the sub-coupon;

generating sub-coupon issuing activity contents matching the coupon issuing activity content based on the coupon issuing activity content, where the sub-coupon issuing activity contents respectively correspond to the sub-coupon templates; and

storing an association relationship between the sub-coupon issuing activity contents and the coupon issuing activity content, or establishing an association between the coupon issuing activity content and the sub-coupon templates.

In some embodiments, before the step of parsing the coupon package, the method includes:

determining whether the coupon-package issuing request for the created coupon package containing the two or more sub-coupons contains information that satisfies the coupon-package issuing condition of the coupon package, and if a result of the determination is yes, performing the step of parsing the coupon package.

In some embodiments, the coupon-package issuing condition specifically is a time range for issuing, a quantity range for issuing, an issuing type and/or a quantity range for holding of the coupon package.

In some embodiments, determining whether the coupon-package issuing request for the created coupon package containing the two or more sub-coupons contains information that satisfies the coupon-package issuing condition of the coupon package includes:

determining whether time of the coupon-package issuing request is within a set time range for issuing of the coupon package, and if a result of the determination is yes, proceeding to the step of parsing the coupon package; or

determining whether a number of times for collecting the coupon package by a requesting party sending the coupon-package issuing request is within a quantity range for collecting of the coupon package, and if a result of the determination is yes, proceeding to the step of parsing the coupon package.

The present application provides an apparatus for issuing a coupon based on an internet platform, including:

a receiving unit configured to receive a coupon-package issuing request for a coupon package;

a parsing unit configured to parse the received coupon package, to obtain each of sub-coupons contained in the coupon package;

a sending unit configured to, for each of the obtained sub-coupons, send a sub-coupon issuing request for issuing the sub-coupon to a coupon issuing party;

a confirmation-information determining unit configured to determine whether confirmation information on the sub-coupon issuing request corresponding to each of the sub-coupons is received; and if a result of the determination is yes, enable a generating-sending unit; and

the generating-sending unit configured to generate confirmation information on the coupon-package issuing request and send to a party sending the coupon-package issuing request.

In some embodiments, the apparatus for issuing a coupon based on an internet platform includes:

a creating unit configured to create the coupon package containing two or more sub-coupons.

In some embodiments, the creating unit includes:

a constructing unit configured to construct a coupon issuing activity content of the coupon package, where the coupon issuing activity content includes a coupon-package issuing condition of the coupon package;

a selecting unit configured to select sub-coupon issuing activity contents of the sub-coupons corresponding to the coupon issuing activity content, and select sub-coupon templates respectively corresponding to the sub-coupon issuing activity contents, where the sub-coupon template defines a coupon type, a coupon amount, a coupon usage restriction and/or a coupon usage instruction of the sub-coupon; and

an establishing unit configured to establish an association relationship between the sub-coupon issuing activity contents and the coupon issuing activity content, or establish an association relationship between the coupon issuing activity content and the sub-coupon templates.

In some embodiments, the creating unit includes:

an establishing unit configured to establish a coupon issuing activity content of the coupon package and two or more sub-coupon templates, where the coupon issuing activity content includes a coupon-package issuing condition, and the sub-coupon template defining a coupon type, a coupon amount, a coupon usage restriction and/or a coupon usage instruction of the sub-coupon;

a generating unit configured to generate sub-coupon issuing activity contents matching the coupon issuing activity content based on the coupon issuing activity content, where the sub-coupon issuing activity contents respectively correspond to the sub-coupon templates; and

a storage unit configured to store an association relationship between the sub-coupon issuing activity contents and the coupon issuing activity content, or establish an association between the coupon issuing activity content and the sub-coupon templates.

In some embodiments, the apparatus for issuing a coupon based on an internet platform includes:

an issuing-condition determining unit configured to determine whether the coupon-package issuing request for the created coupon package containing the two or more sub-coupons contains information that satisfies a coupon-package issuing condition of the coupon package, and if a result of the determination is yes, enable the parsing unit.

Compared with the related art, this application has the following advantages.

Through the method and the apparatus for presenting a coupon based on an internet platform provided by the present application, a coupon package created in advance can be present to the user on the e-commerce application platform of his terminal device, all the sub-coupons in the coupon package can be listed on the platform interface of the e-commerce application after a successful operation action (that is, an issuing request) on the coupon package, and the information of all the sub-coupons that have been collected can be informed to the user through the presenting interface. The presenting method only requires operation on the coupon package on the interface to obtain multiple sub-coupons collected successfully, which can make the coupon collecting operation easier and allow the user to be aware of the status of the sub-coupons they own.

The embodiment of the method and the apparatus for issuing a coupon based on an internet platform are also provided by the present application. Through the issuing method provided by the present application, the user can trigger the service provider through his operation on the coupon package displayed on the platform interface of the e-commerce application platform of his terminal device, the service provider determines based on the operation whether the issuing request on the coupon package satisfied its issuing condition, and if the issuing condition is satisfied, issue all sub-coupons in the created coupon package to the user at one time, thereby simplifying the operation for and improving the efficiency of collecting the coupons.

### BRIEF DESCRIPTION OF THE DRAWINGS

FIG. 1 is a schematic diagram illustrating data transmission in a process of issuing coupons in the related art;

FIG. 2 is a schematic diagram illustrating data transmission in a process of issuing coupons based on a method for presenting a coupon based on an internet platform provided by the present application;

FIG. 3 is a flowchart illustrating a method for presenting a coupon based on an internet platform provided by the present application;

FIG. 4 is a flowchart illustrating a first embodiment of creating a coupon package in a method for presenting a coupon based on an internet platform provided by the present application;

FIG. 5 is a flowchart illustrating a second embodiment of creating a coupon package in a method for presenting a coupon based on an internet platform provided by the present application;

FIG. 6 is a schematic block diagram illustrating an apparatus for presenting a coupon based on an internet platform provided by the present application;

FIG. 7 is a schematic block diagram illustrating a first embodiment of a creating unit in an apparatus for presenting a coupon based on an internet platform provided by the present application;

FIG. 8 is a schematic block diagram illustrating a second embodiment of a creating unit in an apparatus for presenting a coupon based on an internet platform provided by the present application;

FIG. 9 is a flowchart illustrating a method for issuing a coupon based on an internet platform provided by the present application;

FIG. 10 is a flowchart illustrating a first embodiment of creating a coupon package in a method for issuing a coupon based on an internet platform provided by the present application;

FIG. 11 is a flowchart illustrating a second embodiment of creating a coupon package in a method for issuing a coupon based on an internet platform provided by the present application;

FIG. 12 is a structural block diagram illustrating an apparatus for issuing a coupon based on an internet platform provided by the present application;

FIG. 13 is a structural block diagram illustrating a first embodiment of a creating unit in an apparatus for issuing a coupon based on an internet platform provided by the present application;

FIG. 14 is a structural block diagram illustrating a second embodiment of a creating unit in an apparatus for issuing a coupon based on an internet platform provided by the present application.

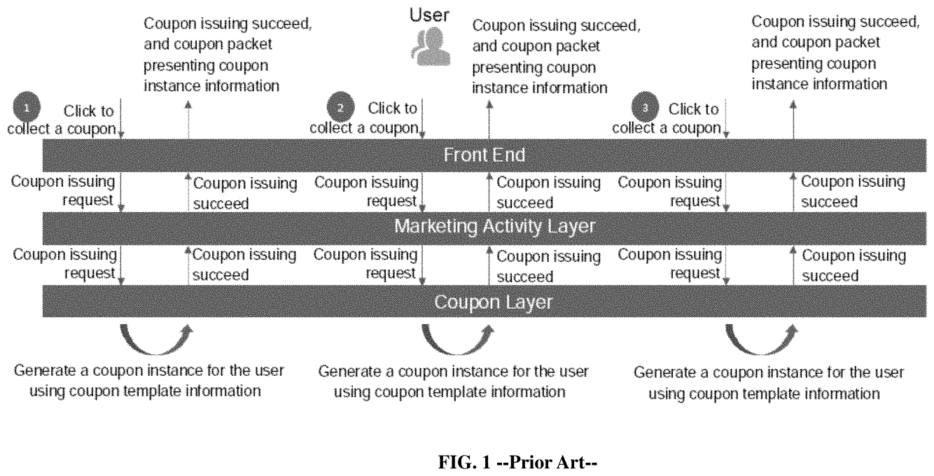

### DETAILED DESCRIPTION OF THE EMBODIMENTS

In the following description, many specific details are set forth in order to fully understand the present application. However, the present application can be implemented in many other ways than those described here. Those skilled in the art can make similar promotion without violating the connotation of the present application, so the present application is not limited by the specific implementation disclosed below.

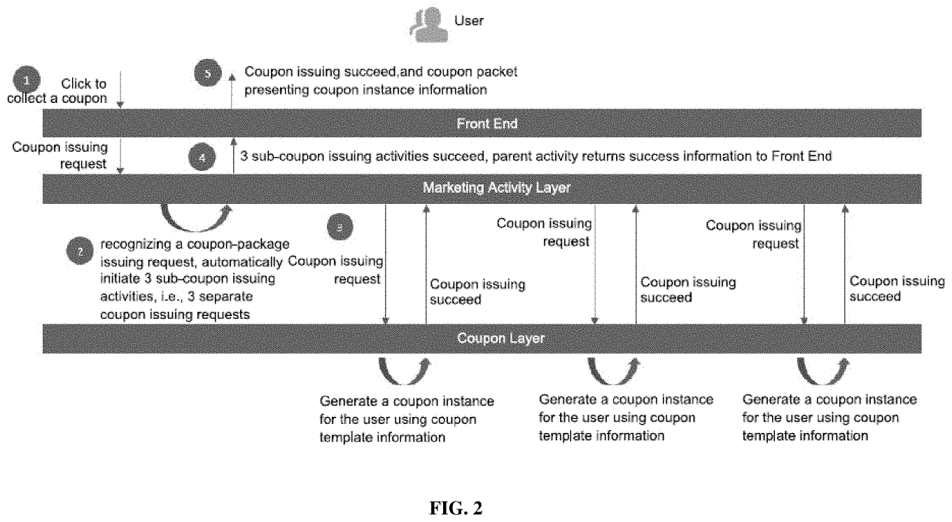

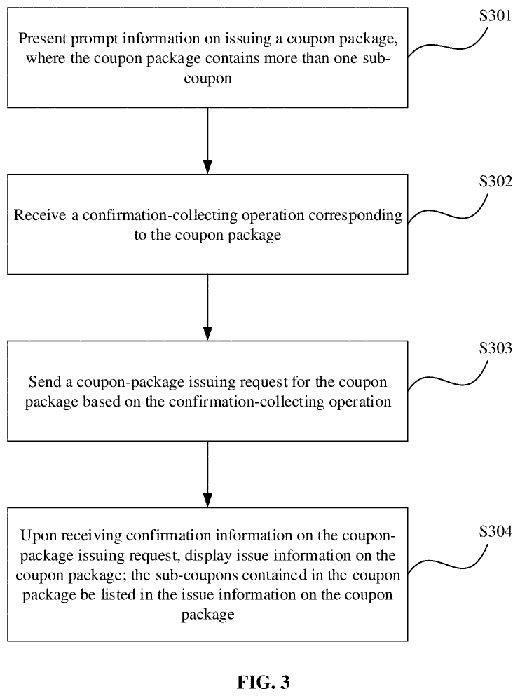

Referring to FIG. 2 and FIG. 3, FIG. 2 is a schematic diagram illustrating data transmission in a process of issuing coupons subject to a method for presenting a coupon based on an internet platform provided by the present application; and FIG. 3 is a flowchart illustrating a method for presenting a coupon based on an internet platform provided by the present application.

As shown in FIG. 3, a method for presenting a coupon based on an internet platform provided by the present application includes steps as follows.

At step S301, prompt information on issuing a coupon package is presented, where the coupon package contains two or more sub-coupons.

This step is used to provide a prompt that the coupon package can be collected, to potential coupon collectors through a client interface.

The coupon package in the present application refers to one coupon-package which can be formed by packing a plurality of coupons of different products from different merchants and/or from the same merchant, upon operating the coupon package, the plurality of coupons of different products from the different merchants and/or from the same merchant in the coupon package can be acquired at one time.

The prompt information of the coupon package is a prompt presented to the potential collectors in an interactive interface (an application interface of a terminal e-commerce platform) that the coupon package can be collected, for example, a gift package icon, a coupon package icon or a gift package icon which moves on a mobile screen and can be clicked. The prompt information can be presented in the interactive interface in a fixed form or can be a pop-up icon set based on a preset presenting time and/or different user status, for example, a coupon package icon can be set to pop up at a certain presenting time, to pop up based on the status such as consumption, browsing, and location of different users, or to pop up based on both a pop-up time of the coupon package icon and a user condition.

It can be understood that the coupon package can also be presented in a form of a barcode or a two-dimensional code.

The prompt information on issuing the coupon package is presented, that is, the prompt information on issuing the coupon package is provided to a potential collector in an appropriate manner, based on an interface status provided by a terminal used by the potential collector and in accordance with a specific usage scenario. For example, for a mobile terminal, prompt information informing collection via a click is provided, and in a specific instance, a gift package pops up and all the coupons in the gift package are listed upon clicking; for a PC client, a URL link can also be used. In some cases, the prompt information can also be presented in the form of sound. As specific presenting scenario, the prompt information can be provided at a certain position on an access interface of an internet application platform when a client is accessing the access interface, or can be pushed through an APP (application) to a client interface satisfying some condition.

Prior to this step, the coupon package should be prepared for collecting; that is, prior to step S301, the method includes: the coupon package containing two or more sub-coupons is created in advance.

The specific method for preparing the coupon package will be explained in detail below.

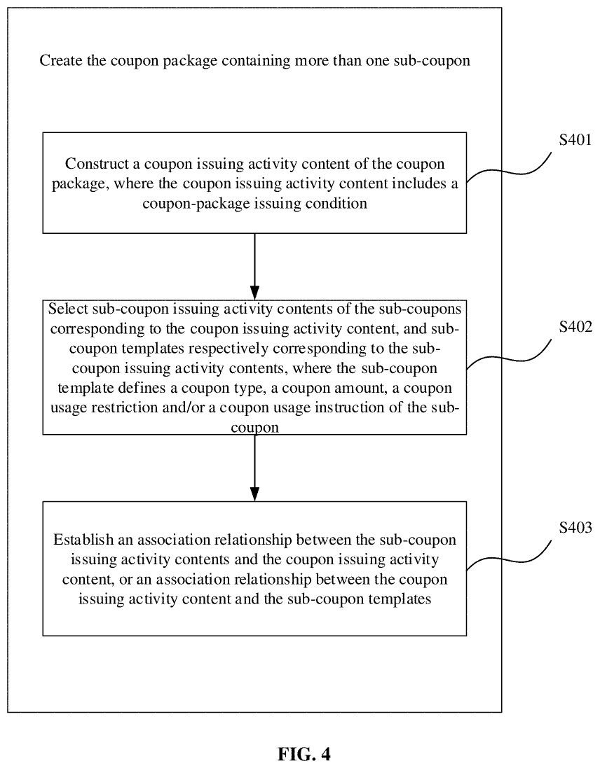

Referring to FIG. 4, FIG. 4 is a flowchart illustrating a first embodiment of creating a coupon package in a method for presenting a coupon based on an internet platform provided by the present application.

At step S401, a coupon issuing activity content of the coupon package is constructed, where the coupon issuing activity content includes at least a coupon-package issuing condition.

This step mainly provides related status on constructing the coupon package; this is a prerequisite for forming the coupon package.

The coupon issuing activity content refers to a description of various status related to the coupon issuing activity. To issue a coupon, the name of the coupon should be provided, for example, Double Twelve Gift Pack, or the like; the condition for issuing the coupon should be provided, for example, starting and ending time of issuing the coupon; and some other details should be provided, such as a preferential benefit provider, a content of the preferential benefit included in the coupon.

It should be noted that, the information on the coupon issuing activity content can be partially presented on the icon which presents the prompt information on the coupon package, such as the name of the coupon (the coupon package), and a total amount of the preferential benefit; of course, alternatively, none of the information on the coupon issuing activity content can be presented.

In this embodiment, the coupon can refer to a “coupon package”. Therefore, the coupon issuing activity content can include the name of the coupon package, the coupon-package issuing condition for issuing the coupon package, sub-coupons contained in the coupon package, preferential benefit providers of various sub-coupons, and so on. Among those, for the present application, the coupon-package issuing condition for issuing the coupon package is focused on.

The coupon-package issuing condition can refer to: a prior action required for issuing the coupon package, that is, for the coupon package, a time range for issuing, a quantity range for issuing and collecting, an issuing type, and/or a quantity range for holding, and so on. The coupon-package issuing condition can be set when the coupon issuing activity content of the coupon package being set.

After the settings of the coupon issuing activity content of the coupon package have finished, products of merchants which participate in the preferential benefit activity are selected to constitute the sub-coupons of the coupon package, as described below.

At step S402, sub-coupon issuing activity contents of the sub-coupons corresponding to the coupon issuing activity content, and sub-coupon templates respectively corresponding to the sub-coupon issuing activity contents, are selected, where the sub-coupon template defines a coupon type, a coupon amount, a coupon usage restriction and/or a coupon usage instruction of the sub-coupon.

The specific implementation process of the step S402 can be: selecting existing coupon activity contents matching the coupon issuing activity content of the coupon package from a business circle as the sub-coupon issuing activity contents, and selecting the sub-coupon templates corresponding to the sub-coupon issuing activity contents, the sub-coupon templates are in one-to-one correspondence with the sub-coupon issuing activity contents.

Selecting existing coupon activity contents matching the coupon issuing activity content of the coupon package from a business circle as the sub-coupon issuing activity contents can be that, the sub-coupon issuing activity contents match the coupon issuing activity content, that is to say, the selection of the sub-coupon issuing activity contents is subject to the coupon issuing activity content of the coupon package, or in other words, the sub-coupon issuing activity contents are inherited from the coupon issuing activity content of the coupon package.

It should be noted that the sub-coupon template defines the coupon information sent to the user, that is, an interpretation on the coupon. The coupon information can specifically be: a coupon type, a coupon amount, a coupon usage restriction and/or a coupon usage instruction of the sub-coupon. The coupon type can be a voucher coupon or a discount coupon, or the like; the coupon amount can be a discount rate, a discount amount, a capped discount amount, or the like; the coupon usage restriction can be a coupon validity period, a usage threshold, or the like; the coupon usage instruction can be the merchant's instruction on how to use the products participating in the activity, or the like.

Based on the above description, in this implementation, the coupon issuing activity content defines how the coupon is issued to the user. The information included in the coupon issuing activity content can specifically be a name of the coupon package, a time range for issuing, a quantity range for issuing and collecting, an issuing type and/or a quantity range for holding of the coupon package. The time range for issuing can be the starting and ending time of issuing the coupon; the quantity range for issuing can be the quantity for collecting; the issuing type can be initiative-taking coupon or gift-with-purchase coupon; and the quantity range for holding can be the number of the coupon packages owned by the same user.

It should be noted that, since the sub-coupon issuing activity contents are inherited from the coupon issuing activity content, the implementation of issuing the coupon issuing activity content of the coupon package is also applicable to the sub-coupon issuing activity contents.

At step S403, an association relationship between the sub-coupon issuing activity contents and the coupon issuing activity content is established, or an association relationship between the coupon issuing activity content and the sub-coupon templates is established.

The specific implementation process of the step S403 can be that, each of the sub-coupon issuing activity contents is associated with the coupon issuing activity content; or the sub-coupon issuing activity contents are associated with one another, and then at least one of the sub-coupon issuing activity contents is associated with the coupon issuing activity content.

The specific implementation of the association relationship can be that the id of each of the sub-coupon issuing activity contents is associated with the id of the coupon issuing activity content, or that the ids of the sub-coupon issuing activity contents are associated with one another and then the id of at least one of the sub-coupon issuing activity contents is associated with the id of the coupon issuing activity content (of the coupon package).

Based on the above content, the association relationship being established between the coupon issuing activity content and the sub-coupon templates can also be specifically that, each of the sub-coupon templates is associated with the coupon issuing activity content; or the sub-coupon templates are associated with one another, and then at least one of the sub-coupon templates is associated with the coupon issuing activity content.

The method for establishing the association relationship can also be that an identifier of each of the sub-coupon templates is associated with an identifier of the coupon issuing activity content, or that the identifiers of the sub-coupon templates are associated with one another and then the identifier of at least one of the sub-coupon templates is associated with the identifier of the coupon issuing activity content. The identifier can be a coupon id.

It should be noted that the coupon issuing activity content is contained in the coupon package, or that the coupon issuing activity content is embodied and presented to the user through the coupon package. The coupon package can be presented on the e-commerce application platform of the terminal, and the corresponding coupon issuing activity content of the coupon package is associated with the sub-coupon templates or the sub-coupon issuing activity contents of the sub-coupons, where the coupon issuing activity content defines the nature of the coupon package. Therefore, the identifier of the coupon package can also be understood as the identifier of the coupon issuing activity content.

It can be understood that, the establishment of the association relationship between the sub-coupon issuing activity contents and the coupon issuing activity content or the establishment of the association relationship between the coupon issuing activity content and the sub-coupon templates is not limited to being associated via id as described above, and it is also possible to associate the information in the sub-coupon issuing activity contents with the information in the coupon issuing activity content, for example, a type identifier of the preferential benefit product and so on.

One implementation process of creating the coupon package containing two or more sub-coupons has been described above, which can be understood as creating the coupon package based on existing preferential benefit information of the merchants. Another implementation of creating in advance the coupon package containing two or more sub-coupons will be described below.

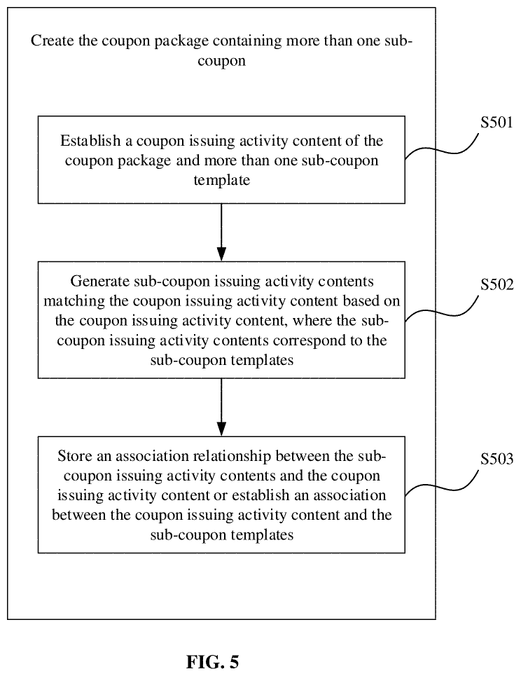

Referring to FIG. 5, FIG. 5 is a flowchart illustrating a second embodiment of creating a coupon package in a method for presenting a coupon based on an internet platform provided by the present application.

At step S501, a coupon issuing activity content of the coupon package and two or more sub-coupon templates are established.

The specific implementation process of the step S501 is as follows.

The coupon issuing activity content of the coupon package is established based on a merchant's marketing strategy, where the coupon issuing activity content includes information of the coupon package, such as a time range for issuing, a quantity range for issuing, an issuing type, and/or a quantity range for holding; a plurality of sub-coupon templates are established sequentially based on the coupon issuing activity content, where the sub-coupon template can define coupon information sent to the user, and the coupon information can specifically be a coupon type, a coupon amount, a coupon usage restriction and/or a coupon usage instruction of the sub-coupon. The coupon usage restriction can be a usage threshold and/or usage period, or the like; the coupon type can be a voucher coupon or a discount coupon, or the like; the coupon amount can be a coupon discount rate, a coupon discount amount, a capped coupon discount amount, or other information. Where, the concepts involved such as the coupon issuing activity content, the sub-coupon issuing activity content and the sub-coupon template can refer to the description of the first embodiment of creating the coupon package, which will not be elaborated herein.

At step S502, two or more sub-coupon issuing activity contents matching the coupon issuing activity content are generated based on the coupon issuing activity content, where the sub-coupon issuing activity contents respectively correspond to the sub-coupon templates.

The specific implementation process of the step S502 is as follows.

On the basis of the coupon issuing activity content of the coupon package and at least two sub-coupon templates being established at step S501, sub-coupon issuing activity contents matching the coupon issuing activity content of the coupon package are generated based on the coupon issuing activity content. That is to say, the information defined in the sub-coupon issuing activity contents is the same as the information defined in the coupon package (the coupon issuing activity content).

The sub-coupon issuing activity contents are in one-to-one correspondence with the sub-coupon templates, that is to say, the generated sub-coupon issuing activity contents and the sub-coupon templates are equivalent in quantity and correspond to each other. In other words, the sub-coupon template and the sub-coupon issuing activity content constitute the sub-coupon.

The specific generation process can be that a plurality of the sub-coupon issuing activity contents are generated by copying directly the coupon issuing activity content, where the plurality of sub-coupon issuing activity contents are recorded in the information of the sub-coupons, that is, the coupon issuing activity content is the same as the sub-coupon issuing activity content.

At step S503, an association relationship between the sub-coupon issuing activity contents and the coupon issuing activity content is stored, or an association between the coupon issuing activity content and the sub-coupon templates is established.

The specific implementation process of the step S503 is as follows.

Since the sub-coupon issuing activity contents are generated based on the coupon issuing activity content, an association relationship between the sub-coupon issuing activity contents and the coupon issuing activity content has existed during the generating process, and can be readily stored. When the issuing is implemented, since there is an association relationship between the coupon issuing activity content (the coupon package) and the sub-coupon issuing activity contents, the coupon issuing action of the sub-coupon issuing activity contents can be completed by simply calling a coupon issuing interface.

Similarly, the sub-coupon templates are in one-to-one correspondence with the sub-coupon issuing activity contents, and there is also an association relationship between the sub-coupon templates and the sub-coupon issuing activity contents. Therefore, only the association relationship between the coupon issuing activity contents and the sub-coupon templates has to be established, so that an association between the coupon issuing activity content (the coupon package) and the sub-coupon issuing activity contents can also be realized, and the coupon issuing action can be implemented by calling the coupon issuing interface.

It can be understood that before the prompt information on issuing the coupon package being presenting at step S301, the method can include the following step.

Determining whether the coupon-package issuing condition of the coupon package which has been created and contains at least two sub-coupons is satisfied, and if the condition is satisfied, the step of presenting the prompt information on issuing the coupon package is performed. In other words, a threshold is provided for issuing the coupon package, and only if the issuing condition is satisfied, the prompt information on issuing the coupon package will be presented.

At step S302, a confirmation-collecting operation corresponding to the coupon package is received.

The specific implementation process of the step S302 can be a confirmation-collecting operation on the coupon package. The confirmation-collecting operation has various implementation forms, for example, a clicking operation on the icon of the coupon package displayed on the interactive interface displayed on the client (the application interface of the e-commerce platform), a scanning operation on the barcode or the two-dimensional code displayed for the coupon package, or the like.

In this implementation, the coupon package can be displayed on the application interface of the e-commerce platform on the terminal device in the form of an icon, and the confirmation-collecting operation can be implemented by clicking the icon. Of course, in fact, the confirmation-collecting operation can also be implemented through the above two-dimensional code or barcode.

The specific implementation process of the step S302 can also be that after the step S301 is satisfied, the confirmation-collecting operation on the coupon package is automatically implemented.

At step S303, a coupon-package issuing request for the coupon package is sent based on the confirmation-collecting operation.

Following an action of performing a collecting operation on the application interface of the e-commerce platform of the client, in the step S303, the coupon-package issuing request for the coupon package is sent through the application interface of the e-commerce platform of the client to the service provider which has created the coupon package.

At step S304, upon receiving confirmation information on the coupon-package issuing request, issue information on the coupon package is displayed; the sub-coupons contained in the coupon package is listed in the issue information on the coupon package.

The specific implementation process of step S304 is as follows. Upon receiving the coupon-package issuing request for the coupon package, the service provider of the coupon initiates a sub-coupon issuing request corresponding to the sub-coupon in the coupon package, calls the sub-coupon template based on the sub-coupon issuing request to generate a sub-coupon corresponding to the sub-coupon activity content, puts the sub-coupon into the coupon package, and presents the sub-coupon by expanding the coupon package on the commerce platform. That is to say, the sub-coupon is contained in the coupon package, and the coupon package is displayed in an expanded form when finally displayed on the commerce platform, where the information of all the sub-coupons contained in the coupon package is listed after the expansion. Where, the sub-coupon is generated via the sub-coupon template according to the sub-coupon issuing activity content, and the displayed content of the sub-coupon can include the sub-coupon issuing activity content.

In the implementation of the step S304, the issue information on the coupon package being displayed includes that, an operation prompt for sharing the coupon package is provided in displaying the issue information on the coupon package.

A specific implementation of the operation prompt for sharing with friends can be that, a relationship between the operation prompt for sharing with friends and a third-party application is established, upon obtaining an operation action corresponding to the operation prompt for sharing with friends, the service provider calls the associated third-party application and presents the third-party application on the display interface of the commerce platform which can be the current display interface of the coupon package, and subsequent operations are performed by the corresponding third-party application through jumping after an operation action on the third-party application is obtained.

The third-party application can be similar to interactive application software, such as DingTalk, Alipay, WeChat, QQ, Weibo, etc.

In the implementation of the step S304, the issue information on the coupon package being displayed can further include that, a storage operation prompt, which contains a storage location where the coupon package can be stored, is provided in displaying the issue information on the coupon package.

The storage operation prompt can set an operation touch area for storing the coupon package on the interface presenting the coupon package, and upon receiving an operational command on the operation touch area, the service provider provides an interface corresponding to the operation of storing the coupon package to complete the storage of the coupon package. That is, the user can store the coupon package as he desires.

After the operation on the operation touch area is completed, a predetermined storage location is displayed for storage under the current display interface of the coupon package, for example, “Cards and Coupons” or other location information that the user can choose for storage is displayed, and after completing the operation on the Cards and Coupons, the coupon package is stored in the Cards and Coupons.

The information on the storage location can be a displayed storage path, which can be presented as a storage path of the coupon package, for example, the sentence, The collected coupon can be in: “My-Cards and Coupons-Coupons”, is presented on the interface displaying the issue information on the coupon package. That is to say, the storage location of the coupon package can be preset to be directly displayed on the interface for displaying the issue information on the coupon package, or can be set based on user's needs. The set storage location can also be displayed on the interface of the issue information on the coupon.

Regardless of the manner in which the coupon package is stored, in this implementation, viewing the coupon package can be implemented through a viewing operation prompt for the coupon package displayed in displaying the issue information on the coupon package. That is to say, the viewing operation prompt for the coupon package is provided in displaying the issue information on the coupon package, and upon receiving an operation command on the viewing operation prompt, the service provider makes the current interface jump to the interface for storing the coupon package.

In displaying the issue information on the coupon package, all the sub-coupons contained in the coupon package will be listed, that is, in displaying the issue information on the coupon package, all the sub-coupons are presented in the form of a list. In order to provide users with better usage requirements, the sub-coupons can be sorted based on historical consumption records or historical browsing records of a user as the receiver of the coupon package, for example, consumption types are counted based on the historical consumption records of the user, each consumption type is arranged in a priority order, the sub-coupons are filtered in order of arranged consumption types, and then the filtered sub-coupons are arranged in the same priority order and listed on the display interface of the coupon package. That is, the sub-coupons whose consumption type is the nearest to or the same as that of the user are arranged in top positions, or arranged in a position area where is easy for a human user to operate or where a human user may habitually click to operate.

Similarly, the sub-coupons can also be arranged based on the historical browsing records of the user, and the specific implementation process can refer to the above description.

The issue information on the coupon package being displayed, at the step S304, can further include the follows.

In order to facilitate the user to use the obtained coupon package, in the implementation, in displaying the issue information on the coupon package, a usage operation prompt for using the coupon package and/or secondary usage operation prompts for respective sub-coupons can be provided.

When a usage operation prompt for using the coupon package is provided in displaying the issue information on the coupon package, an operation area for usage can be set on the display interface of the coupon package, upon taking an operating action on the operation area, the next interface is jumped to. The next interface can be on the current display interface of the coupon package or an independent display interface. The next interface can list coupon information on all the sub-coupons, and provide a usage operation prompt for each of the sub-coupons, and the user can use the sub-coupons selectively as he desires. When the selected sub-coupons are triggered, by calling the ports of the merchants associated with the sub-coupons, the information on the marketing products of all the merchants participating in the sub-coupons is presented on the terminal's e-commerce application platform, where the presentation of the information on the marketing products of the merchants can also be sorted in a priority order based on the historical consumption records or the historical browsing records of the user to improve user experience.

The step of the usage operation prompt for using the coupon package being provided in displaying the issue information on the coupon package can also be that, upon triggering the usage operation prompt, a selection operation prompt for various sub-coupons is displayed. Specifically, when the usage operation prompt for the coupon package is triggered, a selection operation prompt interface for various sub-coupons is displayed on the display interface displaying the issue information on the coupon package, and upon taking a triggering operation on the selection operation prompt interface, an interface of the information on the marketing products of the merchants subject to the sub-coupon is jumped to.

When secondary usage operation prompts for respective sub-coupons are provided in displaying the issue information on the coupon package, an operating action can be taken on an operation area, which can be set for usage on each sub-coupon listed in the display interface of the coupon package, to jump to the next interface corresponding to the triggered sub-coupon. The next interface can list the information on all the marketing products of the merchants corresponding to the sub-coupon, where the presentation of the information on the marketing products of the merchants can also be sorted in a priority order based on the historical consumption records or the historical browsing records of the user to improve user experience.

It can be understood that the usage operation prompt for the coupon package and the secondary usage operation prompts for the sub-coupons can be displayed in displaying the issue information on the coupon package at the same time, or can be displayed separately. When the usage operation prompt for the coupon package and the secondary usage operation prompts for the sub-coupons are displayed at the same time, the user, in accordance with his own preference or operation habit, can perform the usage operation on the coupon package, and also can perform the secondary usage operation on each of the sub-coupons separately. That is to say, the usage operation prompt for the coupon package and the secondary usage operation prompts for the sub-coupons can exist separately or simultaneously.

The issue information on the coupon package being displayed, at step S304, can further include as follows.

A reminder operation prompt for each sub-coupon is provided in displaying the issue information on the coupon package. The specific implementation process can include, but is not limited to, the following two implementations.

First Implementation. Based on current location information of the user, location information of a merchants associated with the sub-coupons presented in the coupon package which match the current location information is searched out, and the usage reminder for the sub-coupons matching the current location information is displayed. Specifically, each type of preferential benefit in the sub-coupons corresponds to information on a plurality of marketing products of various merchants or information on a plurality of different marketing products of the same merchant. By displaying usage reminder operation on the sub-coupons, and upon triggering the usage reminder operation, usage reminder information on the sub-coupons can be displayed on the commerce platform within a set area range. For example, it is provided to counting the sub-coupons corresponding to all merchants within a distance of 1 km from the current location of the user, and the counting results are arranged in a priority order. When the user arrives in the area range, the usage reminder information is sent out through the commerce platform, so as to provide users with preferential benefit activity information more conveniently, and avoid the trouble caused by heavily browsing all sub-coupons and loss of customers. The above process is set upon triggering the reminder operation prompt for the sub-coupons in displaying the issue information on the coupon package, and the process can be implemented as follows.

The service provider dynamically sets a relationship between the current location of the user and the location of the merchants corresponding to the sub-coupons, and the user only needs to select the reminder operation prompt in the display area of the sub-coupons in displaying the issue information on the coupon package, to enable the function of sending a usage reminder information within the location area range.

Second Implementation. Based on the usage time range of the sub-coupon, a usage reminder for the sub-coupon presented in the coupon package within the usage time range is set. That is to say, in the second implementation, a usage reminder operation is displayed on the sub-coupon, and upon triggering the usage reminder operation, usage reminder information on the sub-coupon can be displayed on the commerce platform within a set time range, for example, the usage reminder information is sent three days before the usage time of the sub-coupon. The specific process of setting the usage reminder may be that, reminder operation prompt is set in a display area of the sub-coupon which is existing in displaying the issue information on the coupon package, upon triggering the reminder operation prompt, a setting of the reminder time is enabled, and if the sub-coupon has not be used or the usage count has not be used up within the set time range after the setting is completed, the usage reminder information is displayed on the commerce platform. Alternatively, the service provider has already set reminder operation prompt based on the usage time range of the sub-coupon in advance, and the user only needs to select the reminder operation prompt in the display area of the sub-coupon in displaying the issue information on the coupon package to enable the function of sending the usage reminder information upon expiration.

It can be understood that the sending of the usage reminder information is not limited to the e-commerce platform, but can also be in the form of a short message.

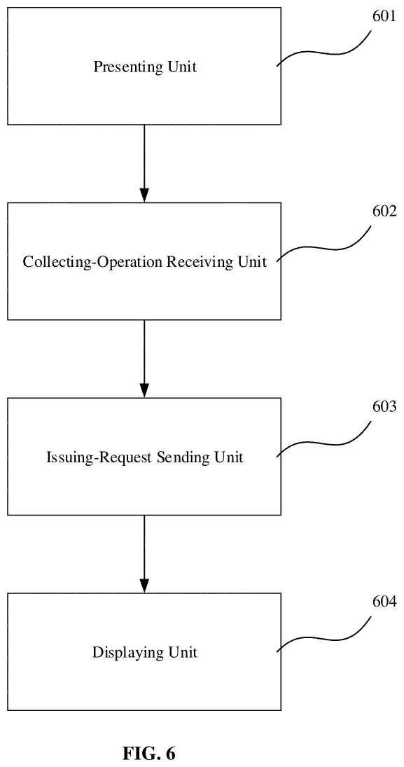

The above is a description of an embodiment of a method for presenting a coupon based on an internet platform according to the present application. Corresponding to the embodiment of a method for presenting a coupon based on an internet platform, the present application also discloses an apparatus for presenting a coupon based on an internet platform. Referring to FIG. 6, FIG. 6 is a schematic block diagram illustrating an apparatus for presenting a coupon based on an internet platform provided by the present application. Since the apparatus embodiments are basically similar to the method embodiments, the description is relatively simple, and the relevant parts can refer to the description of the method embodiments. The apparatus embodiments described below is only schematic.

As shown in FIG. 6, an apparatus for presenting a coupon based on an internet platform provided by the present application includes:

a presenting unit 601 configured to present prompt information on issuing a coupon package, where the coupon package contains two or more sub-coupons;

a collecting-operation receiving unit 602 configured to receive a confirmation-collecting operation corresponding to the coupon package;

an issuing-request sending unit 603 configured to send a coupon-package issuing request for the coupon package based on the confirmation-collecting operation; and

a displaying unit 604 configured to, upon receiving confirmation information on the coupon-package issuing request, display issue information on the coupon package; the sub-coupons contained in the coupon package being listed in the issue information on the coupon package.

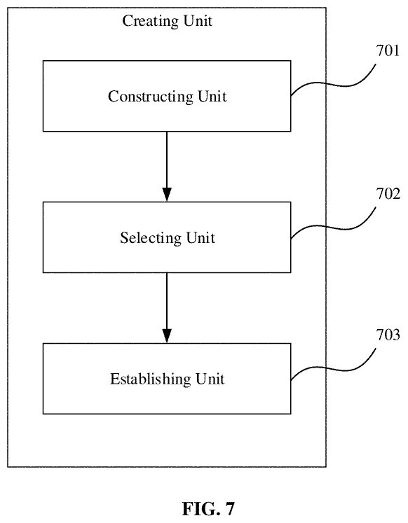

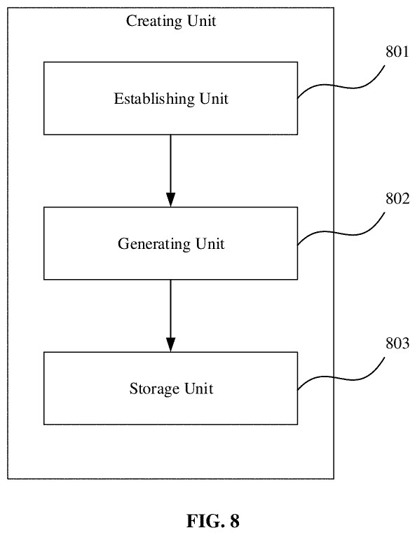

The apparatus for presenting a coupon based on an internet platform provided by the present application further includes: a creating unit configured to create the coupon package containing the two or more sub-coupons. As shown in FIGS. 7 and 8, FIG. 7 is a schematic block diagram illustrating a first embodiment of a creating unit in an apparatus for presenting a coupon based on an internet platform provided by the present application; and FIG. 8 is a schematic block diagram illustrating a second embodiment of a creating unit in an apparatus for presenting a coupon based on an internet platform provided by the present application.

As shown in FIG. 7, the creating unit includes:

a constructing unit 701 configured to construct a coupon issuing activity content of the coupon package, where the coupon issuing activity content is a coupon-package issuing condition of the coupon package;

a selecting unit 702 configured to select sub-coupon issuing activity contents of the sub-coupons corresponding to the coupon issuing activity content, and select sub-coupon templates respectively corresponding to the sub-coupon issuing activity contents; and

an establishing unit 703 configured to establish an association relationship between the sub-coupon issuing activity contents and the coupon issuing activity content, or establish an association relationship between the coupon issuing activity content and the sub-coupon templates.

As shown in FIG. 8, the creating unit includes:

an establishing unit 801 configured to establish a coupon issuing activity content of the coupon package and a plurality of sub-coupon templates;

a generating unit 802 configured to generate sub-coupon issuing activity contents matching the coupon issuing activity content based on the coupon issuing activity content, where the sub-coupon issuing activity contents respectively correspond to the sub-coupon templates; and

a storage unit 803 configured to store an association relationship between the sub-coupon issuing activity contents and the coupon issuing activity content, or establish an association between the coupon issuing activity content and the sub-coupon templates.

The apparatus for presenting a coupon based on an internet platform provided by the present application further includes: an issuing-condition determining unit configured to determine whether coupon-package issuing condition of the created coupon package containing the two or more sub-coupons is satisfied; and if a result of the determination is yes, enable the presenting unit.

The embodiments of the apparatus for presenting a coupon based on an internet platform provided by the present application have been described above. The specific description thereof can refer to the description of the previous embodiments of the method for presenting a coupon based on an internet platform provided by the present application.

Through the method and an apparatus for presenting a coupon based on an internet platform provided by the present application, a coupon package created in advance can be presented to the user on the e-commerce application platform of a terminal device, and after a successful operation on the coupon package, all the sub-coupons in the coupon package can be listed on the platform interface of the e-commerce application, to inform the user of all the sub-coupons that have been collected through the presenting interface. The presenting method only requires operation on the coupon package on the interface to obtain multiple sub-coupons collected successfully, which can make the coupon collecting operation easier and allow the user to be aware of the status of the sub-coupons they own.

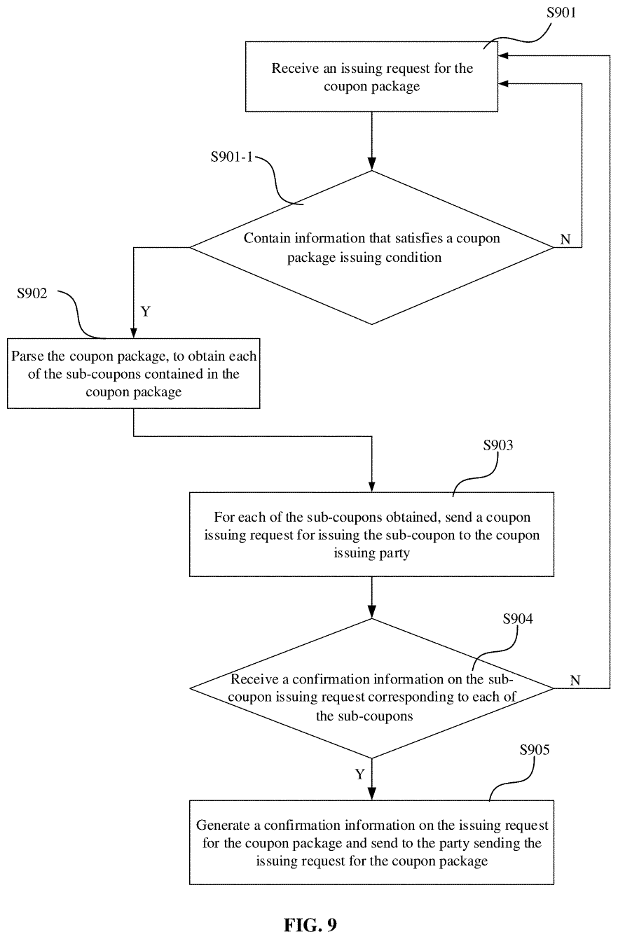

Based on the above embodiments of a method for presenting a coupon based on an internet platform and an apparatus for presenting a coupon based on an internet platform provided by the present application, the present application also provides a method for issuing a coupon based on an internet platform. Referring to FIG. 9, FIG. 9 is a flowchart illustrating a method for issuing a coupon based on an internet platform provided by the present application.

The present application provides a method for issuing a coupon based on the internet platform, including steps S901-S905.

At step S901, a coupon-package issuing request is received.

The specific implementation process of step S901 can be as follows.

First, step S901 is used to receive an issuing request for the coupon package from the client through a service provider that provides preferential benefit activities. Where, the coupon package has to be created in advance.

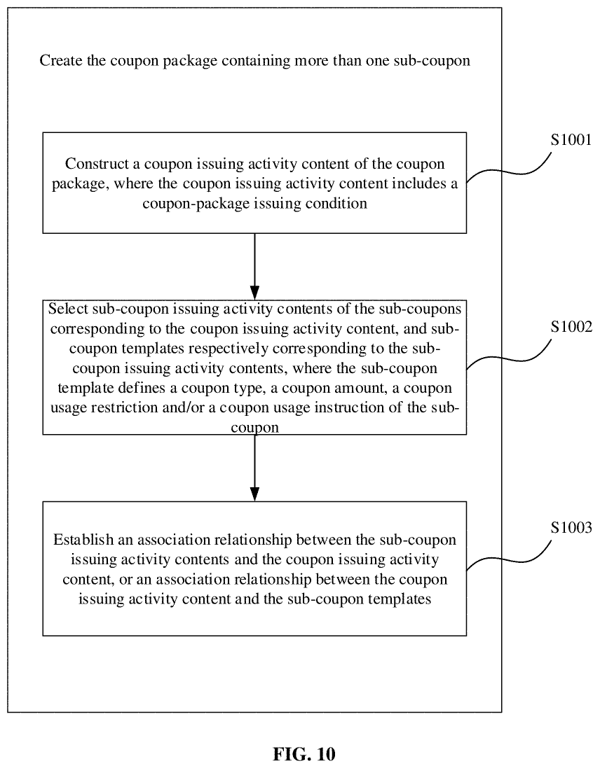

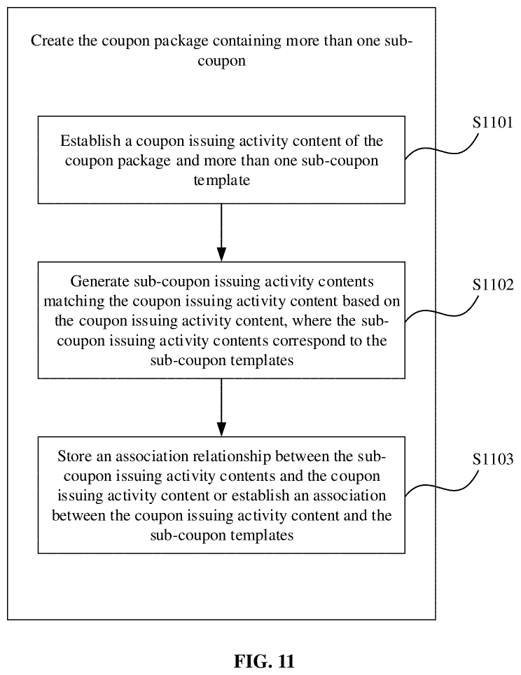

Before receiving the issuing request for the coupon package at step S901, a coupon package containing two or more sub-coupons is created in advance. Creating the coupon package containing the sub-coupons can include two methods, as shown in the creation embodiments provided in FIG. 10 and FIG. 11 respectively.

Referring to FIG. 10, FIG. 10 is a flowchart illustrating a first embodiment of creating a coupon package in a method for issuing a coupon based on an internet platform provided by the present application.

Creating a coupon package containing the two or more sub-coupons includes steps S1001-S1003.

At step S1001, a coupon issuing activity content of the coupon package is constructed, where the coupon issuing activity content includes a coupon-package issuing condition.

At step S1001, the service provider sets a coupon issuing activity content of the coupon package based on the coupon package to be established, where the coupon issuing activity content at least includes the coupon-package issuing condition. Where, the coupon issuing activity content includes the name of the coupon package, the coupon-package issuing condition of the coupon package, sub-coupons contained in the coupon package, preferential benefit providers of respective sub-coupons and so on. For the present application, the main content is the coupon-package issuing condition. The coupon-package issuing condition can be a prior action required for issuing the coupon package, that is, for the coupon package, a time range for issuing, a quantity range for issuing and collecting, an issuing type and/or a quantity range for holding, and so on. The coupon-package issuing condition can be set when the coupon issuing activity content of the coupon package being set.

At step S1002, sub-coupon issuing activity contents of the sub-coupons corresponding to the coupon issuing activity content and sub-coupon templates respectively corresponding to the sub-coupon issuing activity contents are selected, where the sub-coupon template defines a coupon type, a coupon amount, a coupon usage restriction and/or a coupon usage instruction of the sub-coupon.

The specific implementation process of the step S1002 can be: selecting existing coupon activity contents matching the coupon issuing activity content of the coupon package from a business circle participating the marketing activity as the sub-coupon issuing activity contents, and selecting sub-coupon templates corresponding to the sub-coupon issuing activity contents; the sub-coupon templates are in one-to-one correspondence with the sub-coupon issuing activity contents.

Selecting existing coupon activity contents matching the coupon issuing activity content of the coupon package from a business circle as the sub-coupon issuing activity contents can be that, the sub-coupon issuing activity contents match the coupon issuing activity content, that is to say, the selection of the sub-coupon issuing activity contents is subject to the coupon issuing activity content of the coupon package. or in other words, the sub-coupon issuing activity contents are inherited from the coupon issuing activity content of the coupon package.

It should be noted that the sub-coupon template defines the coupon information sent to the user. The coupon information can specifically be a coupon type, a coupon amount, a coupon usage restriction and/or a coupon usage instruction of the sub-coupon. The coupon type can be a voucher coupon or a discount coupon, or the like; the coupon amount can be a discount rate, a discount amount, a capped discount amount, or the like; the coupon usage restriction can be a coupon validity period, a usage threshold, or the like; the coupon usage instruction can be the merchant's instruction on how to use the products participating in the activity, or the like.

Based on the above content, in this implementation, the coupon issuing activity content defines how the coupon is issued to the user. The information included in the coupon issuing activity content can specifically be a name of the coupon package, a time range for issuing, a quantity range for issuing and collecting, an issuing type and/or a quantity range for holding of the coupon package. The time range for issuing can be the starting and ending time of issuing the coupon; the quantity range for issuing can be the quantity for collecting and can be the times of the same coupon packet collected by the same user; the issuing type can be initiative-taking coupon or gift-with-purchase coupon; and the quantity range for holding can be the number of different coupon packages owned by the same user.

It should be noted that, since the sub-coupon issuing activity contents are inherited from the coupon issuing activity content, the implementation of issuing the coupon issuing activity content of the coupon package is also applicable to the sub-coupon issuing activity contents.

At step S1003, an association relationship between the sub-coupon issuing activity contents and the coupon issuing activity content is established, or an association relationship between the coupon issuing activity content and the sub-coupon templates is established.

The specific implementation process of the step S1003 can be that,

each of the sub-coupon issuing activity contents is associated with the coupon issuing activity content; or

the sub-coupon issuing activity contents are associated with one another, and then at least one of the sub-coupon issuing activity contents is associated with the coupon issuing activity content.

The specific implementation of the association relationship can be that the id of each of the sub-coupon issuing activity contents is associated with the id of the coupon issuing activity content, or that the ids of the sub-coupon issuing activity contents are associated with one another and then the id of at least one of the sub-coupon issuing activity contents is associated with the id of the coupon issuing activity content (of the coupon package).

Based on the above content, the association relationship being established between the coupon issuing activity content and the sub-coupon templates can also be specifically that,

each of the sub-coupon templates is established with the coupon issuing activity content; or

the sub-coupon templates are established with one another, and then at least one of the sub-coupon templates is associated with the coupon issuing activity content.

The method for establishing the association relationship can also be that an identifier of each of the sub-coupon templates is associated with an identifier of the coupon issuing activity content, or that the identifiers of the sub-coupon templates is associated with one another and then the identifier of at least one of the sub-coupon templates is associated with the identifier of the coupon issuing activity content. The identifier can be id.

It should be noted that the coupon issuing activity content is contained in the coupon package, or that the coupon issuing activity content is embodied and presented to the user through the coupon package. The coupon package can be presented on the e-commerce application platform of the terminal, and the corresponding coupon issuing activity content of the coupon package is associated with the sub-coupon templates or the sub-coupon issuing activity contents of the sub-coupons, where the coupon issuing activity content defines the nature of the coupon package. Therefore, the identifier of the coupon package can also be understood as the identifier of the coupon issuing activity content.

It can be understood that, the establishment of the association relationship between the sub-coupon issuing activity contents and the coupon issuing activity content or the establishment of the association relationship between the coupon issuing activity content and the sub-coupon templates, is not limited to being associated via id as described above, and it is also possible to associate the information in the sub-coupon issuing activity contents with the information in the coupon issuing activity content, for example, a type identifier of the preferential benefit product and so on.

One implementation process of creating the coupon package containing two or more sub-coupons has been described above, which can be understood as creating the coupon package based on existing preferential benefit information of the merchant. Another implementation of creating in advance the coupon package containing two or more sub-coupons will be described below.

Referring to FIG. 11, FIG. 11 is a flowchart illustrating a second embodiment of creating a coupon package in a method for issuing a coupon based on an internet platform provided by the present application.

Creating a coupon package containing the two or more sub-coupons includes the following steps S1101-S1103.

At step S1101, a coupon issuing activity content of a coupon package and two or more sub-coupon templates are established.

The specific implementation process of the step S1101 is as follows.

The coupon issuing activity content of the coupon package is established based on a merchant's marketing strategy, where the coupon issuing activity content includes information of the coupon package, such as a time range for issuing, a quantity range for issuing, an issuing type, and/or a quantity range for holding; a plurality of sub-coupon templates are established sequentially based on the coupon issuing activity content, where the sub-coupon template can define coupon information sent to the user, and the coupon information can specifically be a coupon type, a coupon amount, a coupon usage restriction and/or a coupon usage instruction of the sub-coupon. The coupon usage restriction can be a usage threshold and/or usage period, or the like; the coupon type can be a voucher coupon or a discount coupon, or the like; the coupon amount can be a coupon discount rate, a coupon discount amount, a capped coupon discount amount, or other information.

At step S1102, two or more sub-coupon issuing activity contents matching the coupon issuing activity content are generated based on the coupon issuing activity content, where the sub-coupon issuing activity contents respectively correspond to the sub-coupon templates.

The specific implementation process of the step S1102 is as follows.

On the basis of the coupon issuing activity content of the coupon package and at least two sub-coupon templates being established at step S1101, sub-coupon issuing activity contents matching the coupon issuing activity content of the coupon package are generated based on the coupon issuing activity content. That is to say, the information defined in the sub-coupon issuing activity contents is the same as the information defined in the coupon package (the coupon issuing activity content).

The sub-coupon issuing activity contents are in one-to-one correspondence with the sub-coupon templates, that is to say, the generated sub-coupon issuing activity contents and the sub-coupon templates are equivalent in quantity and correspond to each other. In other words, the sub-coupon template and the sub-coupon issuing activity content constitute the sub-coupon.

The specific generation process can be that a plurality of the sub-coupon issuing activity contents are generated by copying directly the coupon issuing activity content, where the plurality of sub-coupon issuing activity contents are recorded in the information of the sub-coupons, that is, the coupon issuing activity content is the same as the sub-coupon issuing activity content.

At step S1103, the association relationship between the sub-coupon issuing activity contents and the coupon issuing activity content is stored, or an association between the coupon issuing activity content and the sub-coupon templates is established.

The specific implementation process of the step S1103 is as follows.

Since the sub-coupon issuing activity contents are generated based on the coupon issuing activity content, an association relationship between the sub-coupon issuing activity contents and the coupon issuing activity content has existed during the generating process, and can be readily stored. When the issuing is implemented, since there is an association relationship between the coupon issuing activity content (the coupon package) and the sub-coupon issuing activity contents, the coupon issuing action of the sub-coupon issuing activity contents can be completed by simply calling a coupon issuing interface.

Similarly, the sub-coupon templates are in one-to-one correspondence with the sub-coupon issuing activity contents, and there is also an association relationship between the sub-coupon templates and the sub-coupon issuing activity contents. Therefore, only the association relationship between the coupon issuing activity contents and the sub-coupon templates has to be established, so that an association between the coupon issuing activity content (the coupon package) and the sub-coupon issuing activity contents can also be realized, and the coupon issuing action can be implemented by calling the coupon issuing interface.

FIGS. 10 and 11 provide two methods for creating a coupon package containing at least two sub-coupons, the difference lies in that the creation method provided in FIG. 10 is based on existing sub-coupons, that is, selecting, based on a definite business circle, from marketing product contents of different merchants or the same merchants in the business circle, to constitute the sub-coupons. FIG. 11 provides new sub-coupons, which requires merchants to join in marketing activities and establish sub-coupons for marketing products of the merchants participating the marketing activities.

It can be understood that, no matter which method is used to create the coupon package, before entering the step S902, the method further includes step S901-1.

At step S901-1, it is determined whether the coupon-package issuing request for the created coupon package containing at least two sub-coupons contains information that satisfies the coupon-package issuing condition, and if a result of the determination is yes, the process proceeds to a step of parsing the coupon package; that is, a process of the service provider issuing the coupon package to a potential user who collects the coupon package.

According to the description of the above embodiment of the presenting method and the process of creating the coupon package, the coupon issuing activity content of the coupon package includes a coupon-package issuing condition. That is, the coupon issuing activity content can include various information in which a threshold for issuing a coupon package exists. Therefore, it can be known that the coupon-package issuing condition of the coupon package include specifically a time range for issuing, a quantity range for issuing and collecting, a prior action required for issuing the coupon package, an issuing type, and/or a quantity range for holding, and so on. The coupon-package issuing condition can be set when the coupon issuing activity content of the coupon package being set.

Upon receiving the issuing request for the coupon package, the service provider will determine whether the issuing request contains information that satisfies the coupon-package issuing condition of the coupon package containing at least two sub-coupons that is created in advance. The specific process of determining can include:

determining whether time of the coupon-package issuing request is within the set time range for issuing of the coupon package, and if a result of the determination is yes, proceeding to the next step; specifically, when the user performs a trigger action on the coupon package, determining whether the time for generating the triggering action falls within the set time range for issuing of the coupon package; or

determining whether a number of times for collecting the coupon package by the requesting party sending the coupon-package issuing request is within the quantity range for collecting of the coupon package, and if a result of the determination is yes, proceeding to the next step; specifically, counting the quantity of the same coupon package held by the requesting party, upon receiving the coupon-package issuing request for the coupon package, comparing the quantity of the coupons collected and held by the requesting party with the set quantity for collecting, and if the quantity collected and held exceeds the set quantity, returning an error notification, in which a warning that the quantity for collecting has exceeded the limit can be contained, otherwise, performing the next step; or

determining whether the quantity of the coupon package(s) held by the requesting party sending the coupon-package issuing request is within the set quantity range for holding of the coupon package; if a result of the determination is yes, proceeding to the next step; specifically, by setting a quantity for holding of the coupon package held by each requesting party (may be a user), in determining, first counting the coupon package(s) currently held by the requesting party before the requesting party sends the request, comparing the counting result with the set quantity for holding, and if the counting result exceeds the set quantity for holding, returning an error message; otherwise proceeding to the next step;

where the quantity for collecting can be a setting on the quantity of the same coupon package collected by the same user, that is, the same user can collect the same coupon package for multiple times; and the quantity for holding can be a setting on the quantity of different coupon packages held by the same user, that is, the same user can hold a plurality of different coupon packages via collecting; or

determining whether the coupon-package issuing request satisfies the issuing type; if a result of the determination is yes, proceeding to the next step; specifically, first, in the implementation, the issuing type including: initiative-taking coupon or instant-rebate coupon, where the initiative-taking coupon type is an automatic behavior of the user; and the determining can be combined with the determining of the time of request sending and/or the determining of the quantity of collecting described above, which will not be elaborated herein.

When the issuing type of the coupon is an instant-rebate coupon, the determining can be done only based on the issuing type, that is, it is determined whether the consumption amount of the requesting party sending the request reaches or exceeds an upper limit of the amount of the issuing type, and if a result of the determination is yes, the next step is performed. It can also be determined based on the time of sending the request and/or the quantity of collecting. For the instant-rebate coupon type, after the issuing condition is satisfied, it is possible to automatically perform the issuing or prompt the user to collect the coupon. Regardless which issuing type, the determining can be performed separately or in combination with the above determining of the time, the quantity of collecting and so on.

At step S902, the coupon package is parsed, to obtain each of the sub-coupons contained in the coupon package.

The specific implementation process of the step S902 is that after the determining result is yes at step S901, the coupon package is split, to obtain each of the sub-coupons contained in the coupon package created in advance. Since the coupon package and the sub-coupon have an association relationship, when the coupon package is split, each of the sub-coupons in the coupon package can be obtained in turn by retrieving the identifier of the coupon issuing activity content of the coupon package and retrieving the relevant information of all the sub-coupon issuing activity contents at the same time.

At step S903, for each of the sub-coupons obtained, a sub-coupon issuing request for issuing the sub-coupon is sent to the coupon issuing party.

The specific implementation process of the step S903 is that for each of the sub-coupons obtained after the coupon package is split, the service provider will send a sub-coupon issuing request for the sub-coupon to the coupon issuing party. The sub-coupon issuing requests can be sent to the coupon issuing party at the same time, or can be sent separately in sequence.

At step S904, it is determined whether a successful confirmation information on the sub-coupon issuing request corresponding to each of the sub-coupons is received; and if a result of the determination is yes, step S905 is performed.

At step S905, a confirmation information on the coupon-package issuing request is generated and sent to the party sending the coupon-package issuing request.

During step S904, the party sending the sub-coupon issuing request for the sub-coupon will receive a feedback, the request is successful or not, from the coupon issuing party with respect to the request for issuing the sub-coupon. If the feedback is successful confirmation information with respect to the request for issuing the sub-coupon, the process proceeds to step S905, that is, a successful confirmation information on the coupon-package issuing request is generated.

It should be noted that the confirmation information includes: a successful request information for the sub-coupon and a successful request information for the coupon package. Step S905 is to aggregate the successful request information of the sub-coupons to generate the successful request information on the issuing request for the coupon package and send to the party sending the issuing request for the coupon package. Finally, based on the received success information, the sending party presents a prompt information on issuing a coupon on the application interface of the commerce platform, and all the sub-coupons contained in the coupon package are presented in the prompt information.

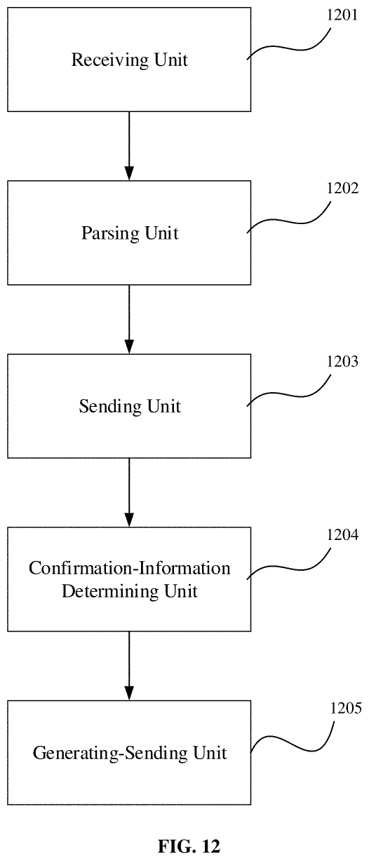

The above is the description of embodiments of a method for issuing a coupon based on an internet platform according to the present application. Corresponding to the embodiments of a method for issuing a coupon based on an internet platform, the present application also discloses an apparatus for issuing a coupon based on an internet platform. Referring to FIG. 12, FIG. 12 is a schematic block diagram illustrating an apparatus for issuing a coupon based on an internet platform provided by the present application. Since the apparatus embodiment is basically similar to the method embodiment, the description is relatively simple, and the relevant part can refer to the description of the method embodiments. The apparatus embodiment described below is only schematic.

Referring to FIG. 12, FIG. 12 is a structural block diagram of an apparatus for issuing a coupon based on an internet platform provided by the present application.

As shown in FIG. 12, the present application provides an apparatus for issuing a coupon based on an internet platform, including:

a receiving unit 1201 configured to receive a coupon-package issuing request for a coupon package; and

before the receiving unit 1201 performs, the apparatus further including:

a creating unit configured to create the coupon package containing two or more sub-coupons.

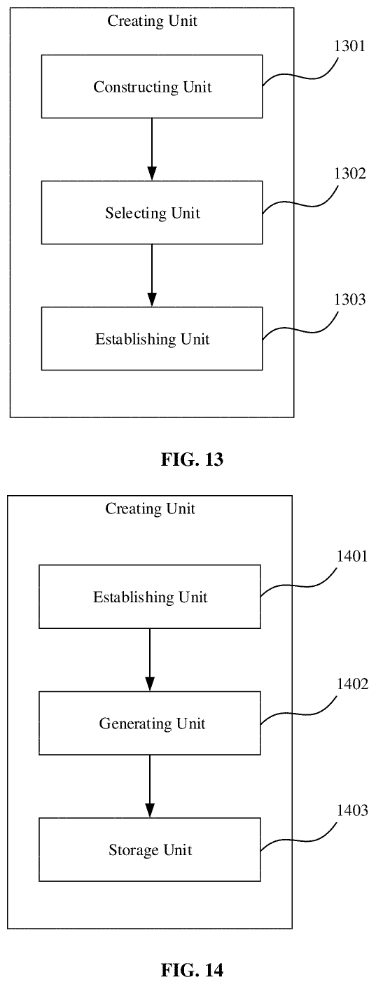

There are two implementations of the creating unit. FIG. 13 is a structural block diagram illustrating a first embodiment of a creating unit in an apparatus for issuing a coupon based on an internet platform provided by the present application; and FIG. 14 is a structural block diagram illustrating a second embodiment of a creating unit in an apparatus for issuing a coupon based on an internet platform provided by the present application. The specific description will be provided below.

As shown in FIG. 13, the creating unit includes:

a constructing unit 1301 configured to construct a coupon issuing activity content of the coupon package, where the coupon issuing activity content includes an issuing condition of the coupon package;

a selecting unit 1302 configured to select sub-coupon issuing activity contents of the sub-coupons corresponding to the coupon issuing activity content, and select sub-coupon templates respectively corresponding to the sub-coupon issuing activity contents, where the sub-coupon template defines a coupon type, a coupon amount, a coupon usage restriction and/or a coupon usage instruction of the sub-coupon; and

an establishing unit 1303 configured to establish an association relationship between the sub-coupon issuing activity contents and the coupon issuing activity content, or establish an association relationship between the coupon issuing activity content and the sub-coupon templates.

As shown in FIG. 14, the creating unit includes:

an establishing unit 1401 configured to establish a coupon issuing activity content of the coupon package and two or more sub-coupon templates, where the coupon issuing activity content includes an issuing condition of the coupon package;

a generating unit 1402 configured to generate sub-coupon issuing activity contents matching the coupon issuing activity content based on the coupon issuing activity content, where the sub-coupon issuing activity contents respectively correspond to the sub-coupon templates, and the sub-coupon template defining a coupon type, a coupon amount, a coupon usage restriction and/or a coupon usage instruction of the sub-coupon; and

a storage unit 1403 configured to store an association relationship between the sub-coupon issuing activity contents and the coupon issuing activity content, or establish an association between the coupon issuing activity content and the sub-coupon templates.

The receiving unit 1201 further includes an issuing-condition determining unit configured to determine whether the issuing request for the created coupon package containing two or more sub-coupons contains information that satisfies a coupon-package issuing condition; and if a result of the determination is yes, enable a parsing unit 1202.

The parsing unit 1202 is configured to parse the coupon package, to obtain each of the sub-coupons contained in the coupon package.

A sending unit 1203 is configured to, for each of the sub-coupons obtained, send a sub-coupon issuing request for issuing the sub-coupon to the coupon issuing party;

A confirmation-information determining unit 1204 is configured to determine whether confirmation information on the sub-coupon issuing request corresponding to each of the sub-coupons is received; and if a result of the determination is yes, enable a generating-sending unit 1205.

The generating-sending unit 1205 is configured to generate confirmation information on the coupon-package issuing request and send to the party sending the coupon-package issuing request.

The embodiments of the apparatus for issuing a coupon based on an internet platform provided by the present application have been described above. Through the issuing method provided by the present application, the user can trigger the service provider to issue all sub-coupons in the created coupon package to the user at one time through an operation action on the coupon package displayed on the platform interface of the e-commerce application platform of the terminal device, thereby simplifying the operation for collecting the coupons, improving the efficiency of collecting the coupons, and improving the user experience.

A method for presenting a coupon based on an internet platform, includes:

presenting prompt information on issuing a coupon package, where the coupon package contains two or more sub-coupons;

receiving a confirmation-collecting operation corresponding to the coupon package;

sending a coupon-package issuing request for the coupon package based on the confirmation-collecting operation; and

upon receiving confirmation information on the coupon-package issuing request, displaying issue information on the coupon package; the sub-coupons contained in the coupon package being listed in the issue information on the coupon package.

The method for presenting a coupon based on an internet platform, before the step of presenting a prompt information on issuing a coupon package, includes:

creating the coupon package containing the two or more sub-coupons.

In the method for presenting a coupon based on an internet platform, creating the coupon package containing the two or more sub-coupons includes:

constructing a coupon issuing activity content of the coupon package, where the coupon issuing activity content includes a coupon-package issuing condition;

selecting sub-coupon issuing activity contents of the sub-coupons corresponding to the coupon issuing activity content, and sub-coupon templates respectively corresponding to the sub-coupon issuing activity contents, where the sub-coupon template defines a coupon type, a coupon amount, a coupon usage restriction and/or a coupon usage instruction of the sub-coupon; and

establishing an association relationship between the sub-coupon issuing activity contents and the coupon issuing activity content, or establishing an association relationship between the coupon issuing activity content and the sub-coupon templates.

In the method for presenting a coupon based on an internet platform, establishing an association relationship between the sub-coupon issuing activity contents and the coupon issuing activity content specifically is:

associating each of the sub-coupon issuing activity contents with the coupon issuing activity content; or

associating the sub-coupon issuing activity contents with one another, and then associating at least one of the sub-coupon issuing activity contents with the coupon issuing activity content; and

establishing an association relationship between the coupon issuing activity content and the sub-coupon templates specifically is:

associating each of the sub-coupon templates with the coupon issuing activity content; or

associating the sub-coupon templates with one another, and then associating at least one of the sub-coupon templates with the coupon issuing activity content.

In the method for presenting a coupon based on an internet platform, creating the coupon package containing the two and more sub-coupons includes:

establishing a coupon issuing activity content of the coupon package and two or more sub-coupon templates, where the coupon issuing activity content includes a coupon-package issuing condition;

generating sub-coupon issuing activity contents matching the coupon issuing activity content based on the coupon issuing activity content, where the sub-coupon issuing activity contents respectively correspond to the sub-coupon templates; and

storing an association relationship between the sub-coupon issuing activity contents and the coupon issuing activity content, or establishing an association between the coupon issuing activity content and the sub-coupon templates.

The method for presenting a coupon based on the internet platform, before presenting prompt information on issuing a coupon package, includes:

determining whether the coupon-package issuing condition of the created coupon package containing the two or more sub-coupons is satisfied, and if a result of the determination is yes, turning to the step of presenting prompt information on issuing a coupon package.

In the method for presenting a coupon based on the internet platform, the coupon-package issuing condition is a time range for issuing, a quantity range for issuing, an issuing type and/or a quantity range for holding.

In the method for presenting a coupon based on the internet platform, displaying issue information on the coupon package includes:

providing an operation prompt for sharing the coupon package in displaying the issue information on the coupon package.

In the method for presenting a coupon based on the internet platform, displaying issue information on the coupon package includes:

providing a storage operation prompt in displaying the issue information on the coupon package, where the storage operation prompt contains a storage location available for storing the coupon package.

In the method for presenting a coupon based on the internet platform, displaying issue information on the coupon package includes:

presenting a viewing operation prompt for viewing the storage location of the coupon package in displaying the issue information on the coupon package.

In the method for presenting a coupon based on the internet platform, displaying issue information on the coupon package includes:

sorting the sub-coupons based on historical consumption records or historical browsing records of a receiver of the coupon package.

In the method for presenting a coupon based on the internet platform, displaying issue information on the coupon package includes:

providing a usage operation prompt for using the coupon package in displaying the issue information on the coupon package, and/or, providing a secondary usage operation prompt for each of the sub-coupons in displaying the issue information on the coupon package.

In the method for presenting a coupon based on the internet platform, providing a usage operation prompt for using the coupon package includes:

upon triggering the usage operation prompt, displaying a selection operation prompt for each of the sub-coupons.

In the method for presenting a coupon based on the internet platform, displaying issue information on the coupon package includes:

providing a usage operation prompt for each of the sub-coupons in displaying the issue information on the coupon package.

In the method for presenting a coupon based on the internet platform, displaying issue information on the coupon package includes:

providing a reminder operation prompt for each of the sub-coupons in displaying the issue information of the coupon package.

In the method for presenting a coupon based on the internet platform, providing a reminder operation prompt for each of the sub-coupons in displaying the information on the coupon package includes:

based on current location information of a user, searching for location information of a merchant associated with the sub-coupon presented in the coupon package which matches the current location information, and displaying a usage reminder for the sub-coupon; or

based on a usage time range of the sub-coupon, setting a usage reminder for the sub-coupon presented in the coupon package within the usage time range.

An apparatus for presenting a coupon based on an internet platform, includes:

a presenting unit configured to present prompt information on issuing a coupon package, where the coupon package contains two or more sub-coupons;

a collecting-operation receiving unit configured to receive a confirmation-collecting operation corresponding to the coupon package;

an issuing-request sending unit configured to send a coupon-package issuing request for the coupon package based on the confirmation-collecting operation; and

a displaying unit configured to, upon receiving confirmation information on the coupon-package issuing request, display issue information on the coupon package; the sub-coupons contained in the coupon package being listed in the issue information on the coupon package.

The apparatus for presenting a coupon based on the internet platform includes:

a creating unit configured to create the coupon package containing the two or more sub-coupons.

In the apparatus for presenting a coupon based on the internet platform, the creating unit includes:

a constructing unit configured to construct a coupon issuing activity content of the coupon package, where the coupon issuing activity content includes a coupon-package issuing condition of the coupon package;

a selecting unit configured to select sub-coupon issuing activity contents of the sub-coupons corresponding to the coupon issuing activity content, and select sub-coupon templates respectively corresponding to the sub-coupon issuing activity contents, where the sub-coupon template defines a coupon type, a coupon amount, a coupon usage restriction and/or a coupon usage instruction of the sub-coupon; and

an establishing unit configured to establish an association relationship between the sub-coupon issuing activity contents and the coupon issuing activity content, or establish an association relationship between the coupon issuing activity content and the sub-coupon templates.

In the apparatus for presenting a coupon based on the internet platform, the creating unit includes:

an establishing unit configured to establish a coupon issuing activity content of the coupon package and a plurality of sub-coupon templates;

a generating unit configured to generate sub-coupon issuing activity contents matching the coupon issuing activity content based on the coupon issuing activity content, where the sub-coupon issuing activity contents respectively correspond to the sub-coupon templates; and

a storage unit configured to store an association relationship between the sub-coupon issuing activity contents and the coupon issuing activity content, or establish an association between the coupon issuing activity content and the sub-coupon templates.

The apparatus for presenting a coupon based on the internet platform includes:

an issuing-condition determining unit configured to determine whether the coupon-package issuing condition of the created coupon package containing the two or more sub-coupons is satisfied, and if a result of the determination is yes, enable the presenting unit.

A method for issuing a coupon based on an internet platform, includes:

receiving a coupon-package issuing request for a coupon package; and

parsing the coupon package, to obtain each of sub-coupons contained in the coupon package;

for each of the sub-coupons obtained, sending a sub-coupon issuing request for issuing the sub-coupon to a coupon issuing party;

determining whether a confirmation information on the sub-coupon issuing request corresponding to each of the sub-coupons is received; and if a result of the determination is yes, performing the next step; and

generating a confirmation information on the coupon-package issuing request and sending to a party sending the coupon-package issuing request.

The method for issuing a coupon based on an internet platform, before the step of receiving a coupon-package issuing request, includes:

creating the coupon package containing two or more sub-coupons.

In the method for issuing a coupon based on an internet platform, creating the coupon package containing two or more sub-coupons includes:

constructing a coupon issuing activity content of the coupon package, where the coupon issuing activity content includes a coupon-package issuing condition of the coupon package;

selecting sub-coupon issuing activity contents of the sub-coupons corresponding to the coupon issuing activity content, and sub-coupon templates respectively corresponding to the sub-coupon issuing activity contents, where the sub-coupon template defines a coupon type, a coupon amount, a coupon usage restriction and/or a coupon usage instruction of the sub-coupon; and

establishing an association relationship between the sub-coupon issuing activity contents and the coupon issuing activity content, or establishing an association relationship between the coupon issuing activity content and the sub-coupon templates.

In the method for issuing a coupon based on an internet platform, establishing an association relationship between the sub-coupon issuing activity contents and the coupon issuing activity content specifically is:

associating each of the sub-coupon issuing activity contents with the coupon issuing activity content; or

associating the sub-coupon issuing activity contents with one another, and then associating at least one of the sub-coupon issuing activity contents with the coupon issuing activity content; and

establishing an association relationship between the coupon issuing activity content and the sub-coupon templates specifically is:

associating each of the sub-coupon templates with the coupon issuing activity content; or

associating the sub-coupon templates with one another, and then associating at least one of the sub-coupon templates with the coupon issuing activity content.

In the method for issuing a coupon based on an internet platform, creating the coupon package containing two or more sub-coupons includes:

establishing a coupon issuing activity content of the coupon package and two or more sub-coupon templates, where the coupon issuing activity content includes a coupon-package issuing condition of the coupon package, and the sub-coupon template defining a coupon type, a coupon amount, a coupon usage restriction and/or a coupon usage instruction of the sub-coupon;

generating sub-coupon issuing activity contents matching the coupon issuing activity content based on the coupon issuing activity content, where the sub-coupon issuing activity contents respectively correspond to the sub-coupon templates; and

storing an association relationship between the sub-coupon issuing activity contents and the coupon issuing activity content, or establishing an association between the coupon issuing activity content and the sub-coupon templates.

The method for issuing a coupon based on an internet platform, before the step of parsing the coupon package, includes:

determining whether the coupon-package issuing request for the created coupon package containing the two or more sub-coupons contains information that satisfies the coupon-package issuing condition of the coupon package, and if a result of the determination is yes, performing the step of parsing the coupon package.

In the method for issuing a coupon based on the internet platform, the coupon-package issuing condition specifically is a time range for issuing, a quantity range for issuing, an issuing type and/or a quantity range for holding of the coupon package.

In the method for issuing a coupon based on an e-commerce platform, determining whether the coupon-package issuing request for the created coupon package containing the two or more sub-coupons contains information that satisfies the coupon-package issuing condition of the coupon package includes:

determining whether time of the coupon-package issuing request is within a set time range for issuing of the coupon package, and if a result of the determination is yes, proceeding to the next step; or

determining whether a number of times for collecting the coupon package by a requesting party sending the coupon-package issuing request is within a quantity range for collecting of the coupon package, and if a result of the determination is yes, proceeding to the next step.

An apparatus for issuing a coupon based on an internet platform, includes:

a receiving unit configured to receive a coupon-package issuing request for a coupon package;

a parsing unit configured to parse the coupon package, to obtain each of sub-coupons contained in the coupon package;

a sending unit configured to, for each of the sub-coupons obtained, send a sub-coupon issuing request for issuing the sub-coupon to a coupon issuing party;

a confirmation-information determining unit configured to determine whether confirmation information on the sub-coupon issuing request corresponding to each of the sub-coupons is received; and if a result of the determination is yes, enable a generating-sending unit; and

the generating-sending unit configured to generate confirmation information on the coupon-package issuing request and send to a party sending the coupon-package issuing request.

The apparatus for issuing a coupon based on an internet platform includes:

a creating unit configured to create the coupon package containing two or more sub-coupons.

In the apparatus for issuing a coupon based on an internet platform, the creating unit includes:

a constructing unit configured to construct a coupon issuing activity content of the coupon package, where the coupon issuing activity content includes a coupon-package issuing condition of the coupon package;

a selecting unit configured to select sub-coupon issuing activity contents of the sub-coupons corresponding to the coupon issuing activity content, and select sub-coupon templates respectively corresponding to the sub-coupon issuing activity contents, where the sub-coupon template defines a coupon type, a coupon amount, a coupon usage restriction and/or a coupon usage instruction of the sub-coupon; and

an establishing unit configured to establish an association relationship between the sub-coupon issuing activity contents and the coupon issuing activity content, or establish an association relationship between the coupon issuing activity content and the sub-coupon templates.

In the apparatus for issuing a coupon based on an internet platform, the creating unit includes:

an establishing unit configured to establish a coupon issuing activity content of the coupon package and two or more sub-coupon templates, where the coupon issuing activity content includes a coupon-package issuing condition, and the sub-coupon template defines a coupon type, a coupon amount, a coupon usage restriction and/or a coupon usage instruction of the sub-coupon;

a generating unit configured to generate sub-coupon issuing activity contents matching the coupon issuing activity content based on the coupon issuing activity content, where the sub-coupon issuing activity contents respectively correspond to the sub-coupon templates; and

a storage unit configured to store an association relationship between the sub-coupon issuing activity contents and the coupon issuing activity content, or establish an association between the coupon issuing activity content and the sub-coupon templates.

The apparatus for issuing a coupon based on an internet platform includes:

an issuing-condition determining unit configured to determine whether the coupon-package issuing request for the created coupon package containing the two or more sub-coupons contains information that satisfies a coupon-package issuing condition of the coupon package, and if a result of the determination is yes, enable the parsing unit.

Although the present application is disclosed as above with some embodiments, it is not intended to limit the present application. Any person skilled in the art can make possible variations and modifications without departing from the spirit and scope of the present application, so the scope of protection of the present application shall be subject to the scope defined in the claims of the present application.

In a typical configuration, a computing device includes one or more processors (CPUs), input/output ports, network ports, and a memory.

The memory can include a non-permanent memory, a random access memory (RAM) and/or a non-volatile memory in a computer-readable medium, such as a read only memory (ROM) or a flash memory (flash RAM). The memory is an example of a computer-readable medium.

1. Computer-readable media, including permanent and non-permanent, removable and non-removable media, can implement information storage by any method or technology. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, read-only compact disc read-only memory (CD-ROM), digital versatile disc (DVD) or other optical storage, magnetic tape cassettes, magnetic tape magnetic disk storage or other magnetic storage devices or any other non-transmission media, can be used to store information that can be accessed by computing devices. As defined herein, computer-readable media does not include non-transitory computer-readable media (transitory media), such as modulated data signals and carrier waves.

2. Those skilled in the art should understand that the embodiments of the present application can be provided as methods, systems, or computer program products. Therefore, the present application can take the form of an entirely hardware embodiment, an entirely software embodiment, or an embodiment combining software and hardware. Moreover, the present application can take the form of a computer program product implemented on one or more computer usable storage media (including but not limited to disk storage, CD-ROM, optical storage, or the like) containing computer usable program code.

In one aspect, an apparatus for presenting a coupon based on an internet platform according to the present disclosure is provided. The apparatus comprises a storage medium on which computer readable instructions are stored; and a processor, where, when the instructions are executed by the processor, the processor is caused to:

presenting prompt information on issuing a coupon package, where the coupon package contains two or more sub-coupons;

receiving a confirmation-collecting operation corresponding to the coupon package;

sending a coupon-package issuing request for the coupon package based on the confirmation-collecting operation; and

upon receiving confirmation information on the coupon-package issuing request, displaying issue information on the coupon package; where the sub-coupons contained in the coupon package are listed in the issue information on the coupon package.

In another aspect, an apparatus for presenting a coupon based on an internet platform according to the present disclosure is provided. The apparatus comprises a storage medium on which computer readable instructions are stored; and a processor, where when the instructions are executed by the processor, the processor is caused to:

receiving a coupon-package issuing request for a coupon package; and

parsing the coupon package, to obtain each of sub-coupons contained in the coupon package;

for each of the obtained sub-coupons, sending a sub-coupon issuing request for issuing the sub-coupon to a coupon issuing party;

determining whether a confirmation information on the sub-coupon issuing request corresponding to each of the sub-coupons is received; and if a result of the determination is yes, performing the next step; and

generating a confirmation information on the coupon-package issuing request and sending to a party sending the coupon-package issuing request.

1. A method for presenting a coupon based on an internet platform, comprising:
presenting prompt information on issuing a coupon package, wherein the coupon package contains two or more sub-coupons;
receiving a confirmation-collecting operation corresponding to the coupon package;
sending a coupon-package issuing request for the coupon package based on the confirmation-collecting operation; and
upon receiving confirmation information on the coupon-package issuing request, displaying issue information on the coupon package; wherein the sub-coupons contained in the coupon package are listed in the issue information on the coupon package.

2. The method for presenting a coupon based on an internet platform according to claim 1, further comprising:
before the step of presenting prompt information on issuing a coupon package, creating the coupon package containing the two or more sub-coupons.

3. The method for presenting a coupon based on an internet platform according to claim 2, wherein creating the coupon package containing the two or more sub-coupons comprises:
constructing a coupon issuing activity content of the coupon package, wherein the coupon issuing activity content includes a coupon-package issuing condition;
selecting sub-coupon issuing activity contents of the sub-coupons corresponding to the coupon issuing activity content, and sub-coupon templates respectively corresponding to the sub-coupon issuing activity contents, wherein the sub-coupon template defines, for the sub-coupon, at least one of a coupon type, a coupon amount, a coupon usage restriction, or a coupon usage instruction; and
establishing an association relationship between the sub-coupon issuing activity contents and the coupon issuing activity content, or establishing an association relationship between the coupon issuing activity content and the sub-coupon templates.

4. The method for presenting a coupon based on an internet platform according to claim 3, wherein establishing an association relationship between the sub-coupon issuing activity contents and the coupon issuing activity content comprises:
associating each of the sub-coupon issuing activity contents with the coupon issuing activity content; or
associating the sub-coupon issuing activity contents with one another, and then associating at least one of the sub-coupon issuing activity contents with the coupon issuing activity content; and
establishing an association relationship between the coupon issuing activity content and the sub-coupon templates comprises:
associating each of the sub-coupon templates with the coupon issuing activity content; or
associating the sub-coupon templates with one another, and then associating at least one of the sub-coupon templates with the coupon issuing activity content.

5. The method for presenting a coupon based on an internet platform according to claim 2, wherein creating the coupon package containing the two or more sub-coupons comprises:
establishing a coupon issuing activity content of the coupon package and two or more sub-coupon templates, wherein the coupon issuing activity content includes a coupon-package issuing condition;
generating sub-coupon issuing activity contents matching the coupon issuing activity content based on the coupon issuing activity content, wherein the sub-coupon issuing activity contents respectively correspond to the sub-coupon templates; and
storing an association relationship between the sub-coupon issuing activity contents and the coupon issuing activity content, or establishing an association between the coupon issuing activity content and the sub-coupon templates.

6. The method for presenting a coupon based on an internet platform according to claim 2, further comprising:
before presenting prompt information on issuing a coupon package, determining whether a coupon-package issuing condition of the created coupon package containing the two or more sub-coupons is satisfied, and if a result of the determination is yes, turning to the step of presenting prompt information on issuing a coupon package.

7. The method for presenting a coupon based on an internet platform according to claim 6, wherein the coupon-package issuing condition includes at least one of a time range for issuing, a quantity range for issuing, an issuing type, or a quantity range for holding.

8. The method for presenting a coupon based on an internet platform according to claim 1, wherein displaying issue information on the coupon package comprises at least one of:
providing an operation prompt for sharing the coupon package in displaying the issue information on the coupon package;
providing a storage operation prompt in displaying the issue information on the coupon package, wherein the storage operation prompt contains a storage location available for storing the coupon package;
presenting a viewing operation prompt for viewing the storage location of the coupon package in displaying the issue information on the coupon package;
sorting the sub-coupons based on historical consumption records or historical browsing records of a receiver of the coupon package;
providing a usage operation prompt for using the coupon package in displaying the issue information on the coupon package;
providing a secondary usage operation prompt for each of the sub-coupons in displaying the issue information on the coupon package;
providing a usage operation prompt for each of the sub-coupons in displaying the issue information on the coupon package; or
providing a reminder operation prompt for each of the sub-coupons in displaying the information on the coupon package.

9-12. (canceled)

13. The method for presenting a coupon based on an internet platform according to claim 8, wherein providing a usage operation prompt for using the coupon package comprises:
upon triggering the usage operation prompt, displaying a selection operation prompt for each of the sub-coupons.

14-15. (canceled)

16. The method for presenting a coupon based on an internet platform according to claim 8, wherein providing a reminder operation prompt for each of the sub-coupons in displaying the information on the coupon package comprises:
based on current location information of a user, searching for location information of a merchant which is associated with the sub-coupon presented in the coupon package and matches the current location information, and displaying a usage reminder for the sub-coupon; or
based on a usage time range of the sub-coupon, setting a usage reminder for the sub-coupon presented in the coupon package within the usage time range.

17. An apparatus for presenting a coupon based on an internet platform, comprising:
a storage medium on which computer readable instructions are stored; and
a processor,
wherein, when the instructions are executed by the processor, the processor is caused to:
present prompt information on issuing a coupon package, wherein the coupon package contains two or more sub-coupons;
receive a confirmation-collecting operation corresponding to the coupon package;
send a coupon-package issuing request for the coupon package based on the confirmation-collecting operation; and
upon receiving confirmation information on the coupon-package issuing request, display issue information on the coupon package; wherein the sub-coupons contained in the coupon package are listed in the issue information on the coupon package.

18-21. (canceled)

22. A method for issuing a coupon based on an internet platform, comprising:
receiving a coupon-package issuing request for a coupon package; and
parsing the coupon package, to obtain each of sub-coupons contained in the coupon package;
for each of the obtained sub-coupons, sending a sub-coupon issuing request for issuing the sub-coupon to a coupon issuing party;
determining whether a confirmation information on the sub-coupon issuing request corresponding to each of the sub-coupons is received; and if a result of the determination is yes, performing the next step; and
generating a confirmation information on the coupon-package issuing request and sending to a party sending the coupon-package issuing request.

23. The method for issuing a coupon based on an internet platform according to claim 22, further comprising:
before the step of receiving a coupon-package issuing request, creating the coupon package containing two or more sub-coupons.

24. The method for issuing a coupon based on an internet platform according to claim 23, wherein creating the coupon package containing two or more sub-coupons comprises:
constructing a coupon issuing activity content of the coupon package, wherein the coupon issuing activity content includes a coupon-package issuing condition of the coupon package;
selecting sub-coupon issuing activity contents of the sub-coupons corresponding to the coupon issuing activity content, and sub-coupon templates respectively corresponding to the sub-coupon issuing activity contents, wherein the sub-coupon template defines, for the sub-coupon, at least one of a coupon type, a coupon amount, a coupon usage restriction, or a coupon usage instruction; and
establishing an association relationship between the sub-coupon issuing activity contents and the coupon issuing activity content, or establishing an association relationship between the coupon issuing activity content and the sub-coupon templates.

25. The method for issuing a coupon based on an internet platform according to claim 24, wherein
establishing an association relationship between the sub-coupon issuing activity contents and the coupon issuing activity content comprises:
associating each of the sub-coupon issuing activity contents with the coupon issuing activity content; or
associating the sub-coupon issuing activity contents with one another, and then associating at least one of the sub-coupon issuing activity contents with the coupon issuing activity content; and
establishing an association relationship between the coupon issuing activity content and the sub-coupon templates comprises:
associating each of the sub-coupon templates with the coupon issuing activity content; or
associating the sub-coupon templates with one another, and then associating at least one of the sub-coupon templates with the coupon issuing activity content.

26. The method for issuing a coupon based on an internet platform according to claim 23, wherein creating the coupon package containing two or more sub-coupons comprises:
establishing a coupon issuing activity content of the coupon package and two or more sub-coupon templates, wherein the coupon issuing activity content includes a coupon-package issuing condition, and the sub-coupon template defines, for the sub-coupon, at least one of a coupon type, a coupon amount, a coupon usage restriction, or a coupon usage instruction;
generating sub-coupon issuing activity contents matching the coupon issuing activity content based on the coupon issuing activity content, wherein the sub-coupon issuing activity contents respectively correspond to the sub-coupon templates; and
storing an association relationship between the sub-coupon issuing activity contents and the coupon issuing activity content, or establishing an association between the coupon issuing activity content and the sub-coupon templates.

27. The method for issuing a coupon based on an internet platform according to claim 23 further comprising:
before the step of parsing the coupon package, determining whether the coupon-package issuing request for the created coupon package containing the two or more sub-coupons contains information that satisfies a coupon-package issuing condition of the coupon package, and if a result of the determination is yes, performing the step of parsing the coupon package.

28. The method for issuing a coupon based on an internet platform according to claim 27, wherein the coupon-package issuing condition includes at least one of a time range for issuing, a quantity range for issuing, an issuing type, or a quantity range for holding with respect to the coupon package.

29. The method for issuing a coupon based on an internet platform according to claim 27, wherein determining whether the coupon-package issuing request for the created coupon package containing the two or more sub-coupons contains information that satisfies the coupon-package issuing condition of the coupon package comprises at least one of:
determining whether time of the coupon-package issuing request is within a set time range for issuing of the coupon package;
determining whether a number of times for collecting the coupon package by a requesting party sending the coupon-package issuing request is within a quantity range for collecting of the coupon package; or
determining whether the coupon-package issuing request satisfies the issuing type of the coupon package.

30-34. (canceled)

35. An apparatus for issuing a coupon based on an internet platform, comprising:
a storage medium on which computer readable instructions are stored; and
a processor,
wherein, when the instructions are executed by the processor, the processor is caused to implement the method according to claim 22.
